(19) United States
(12) Patent Application Publication
(10) Pub. No.: US 2009/0201248 A1
(43) Pub. Date: Aug. 13, 2009

(54) Device and method for providing electronic input

(76) Inventors: Radu Negulescu, Galati (RO); Mihai Vlase, Galiti (RO)

Correspondence Address: EAGLE IP LIMITED, 22/F., KWAI HUNG HOLDINGS CENTRE, 89 KING'S ROAD, NORTH POINT, HK

(21) Appl. No.: 12/307,363

(22) PCT Filed: Jul. 2, 2007
(86) PCT No.: PCT/IB2007/052556

§ 371 Date: Jan. 4, 2009

Related U.S. Application Data
(60) Provisional application No. 60/818,378, filed on Jul. 5, 2006.
(60) Provisional application No. 60/847,674, filed on Sep. 28, 2006.
(60) Provisional application No. 60/902,041, filed on Feb. 20, 2007.

(30) Foreign Application Priority Data
May 5, 2007 (SG) 200704782.2

(51) Int. Cl. G09G 5/08

(52) U.S. Cl. 345/157

(57) ABSTRACT

An input apparatus comprises an input device comprising a shuttle capable to move substantially within a two-dimensional surface when engaged by a user member. The input device and a display are communicatively connected to a host. A cursor is displayed and moved on the display. The shuttle is moved by engaging it and there is kinesthetic or tactile feedback to a user depending on the position of said shuttle within the surface. The feedback indicates that the shuttle travels to one of several preset positions. The input device is biased towards the nearest position within a set of predetermined locations. The cursor is moved in a direction and by a distance substantially similar to the direction and distance traveled by said shuttle. The shuttle may be depressed to select items on the display.

### FIELD

The present application regards a device for providing input into computers, phones, and other electronic appliances.

### BRIEF DESCRIPTION OF THE SEVERAL VIEWS OF THE DRAWINGS

FIG. 1 shows an input device,

FIG. 2 shows a movement sensing mechanism,

FIG. 3A-3F show embodiments of movement sensing mechanism,

FIG. 4A-4I show embodiments of movement sensing system,

FIG. 5A-5B show embodiments of communications interface,

FIG. 6 shows an electronic input system,

FIG. 7A-7D show steps of a method for cursor movement,

FIG. 8A-8H show steps of a method for cursor movement,

FIG. 9A-9D show steps of a method for graphic image manipulation with shifting the image,

FIG. 10A-10G show steps of a method for graphic image manipulation with shifting the image with optional rewind and repeat movements,

FIG. 11A-11E show steps of a method for entering text,

FIG. 12A-12E show steps of a method for selecting menu items and submenus,

FIG. 13A-13H show steps of a method for navigating menu items with optional rewind and repeat movements,

FIG. 14A-14L show steps of a method for navigating menu items with optional click sensor,

FIG. 15A-15C show steps of a method for navigating graphical elements with said input device,

FIG. 16 shows an embodiment of input device,

FIG. 17 shows a handset containing two said input devices,

FIG. 18A-18E show a method for playing board games using said input device,

FIG. 19A-19B show a method for navigating spreadsheets using said input device,

FIG. 20A-20C show a method for guiding a widget using said input device,

FIG. 21A-21C are embodiments for a joystick device with two-dimensional detent systems,

FIG. 21D shows a detail of a guide rail with detent system of FIG. 21C,

FIG. 22A shows an arrow key sensor pad,

FIG. 22B shows a converter circuit that converts signals generated by a wheel encoder into signals generated by arrow key sensors,

FIG. 22C shows a waveform of signals in FIG. 22B,

FIG. 23 shows said input device affixed on a ring,

FIG. 24 shows said input device affixed on a mouse,

FIG. 25 shows said input device on a universal remote control with a graphical user interface,

FIG. 26 shows forms of said kinesthetic feedback,

FIG. 27A shows a longitudinal cross-section of means for implementing snapping,

FIG. 27B shows a view from above of means for implementing snapping of FIG. 27A,

FIG. 27C shows a longitudinal cross-section of means for implementing snapping of FIG. 27A, where snapping is optionally disabled,

FIG. 27D shows a view from above of means for implementing snapping of FIG. 27A, where snapping is optionally disabled,

FIG. 28 shows a view of an actual prototype of the application.

FIG. 29 shows another embodiment of the present application.

### DETAILED DESCRIPTION

In the following description, details are provided to describe the embodiments and examples of the application. It shall be apparent to one skilled on the art, however, that the embodiments may be practised without such details. Some of these details may not be described at length so as not to obscure the embodiments and examples.

The following description gives an overview of examples of the application.

An input device for an electronic device comprises the following features:
a still part for receiving a shuttle, the shuttle being moveable by a user with respect to the still part,
a movement sensing system for converting the position and/or the movements of the shuttle. Movements are position changes of the shuttle with respect to the still part. The conversion provides an electrical information. The movement sensing system is mechanically, electrically, optically or magnetically coupled with the shuttle.
an output for providing the electrical information to the electronic device,
a detent system for engaging the shuttle for providing feedback to the user when said first moving part is displaced with respect to said first still part, the detent system being mechanically, electrically, or magnetically coupled with the shuttle. The detent system can also be mechanically, electrically, or magnetically coupled with the movement sensing system which is coupled with the shuttle, providing thereby a bias force capable of snapping or latching of the shuttle at pre-determined positions.

The movement sensing system can be coupled with the shuttle such that a predetermined range of movement of the shuttle is transformed into a predetermined sensing range of the movement sensing system, thereby maximizing the resolution of the sensing system. A simple movement sensing system comprises a gearing device such as a moveable lever assembly.

The shuttle is preferably movable within two dimensions, wherein the still part can comprise an essentially flat pad for guiding the shuttle or a ball which is rotatably taken up within or on the still part. The shuttle may also comprise a joystick and/or a sensor which is capable of being depressed by applying a force substantially orthogonal on the area that comes in contact with the user, and remaining in a, or reverting to a non-depressed state when the force is not being applied. The sensor provides a kinesthetic, haptic and/or acoustic feedback when switching from one state to another state.

The detent system provides a kinesthetic feedback to the user, especially for the user's touch sense. A simple detent system provides a passive feedback, wherein the position of the shuttle comprises stable equilibrium positions and unstable positions, whereby the shuttle moves from an unstable position to a stable positions without applying external force to the shuttle. The detent system may also provide an acoustic feedback to the user.

An electronic device such as a computer device, with an input device as mentioned above provides the electrical information

from the input device for entering information into the electronic device, providing the functions of a computer, of a mobile phone or of a computer game console.

A computer program for controlling an electronic device comprises a display device with a movable cursor, wherein the computer program is linking pre-determined positions of the shuttle with pre-determined positions of the cursor such that a movement of the shuttle to a pre-determined position provides a movement of the cursor to the pre-determined position on the display which is linked therewith. The electronic device may also comprise a display device, wherein the computer program is linking pre-determined positions of the shuttle with pre-determined images to be displayed on the display.

The pre-determined positions of the shuttle may comprise positions where the detent system provides a feedback at a reduced level or at an increased level. If a sensor is provided, then a click activates an object or an image at a pre-determined position.

In short words, an example of a method for moving a cursor or for changing the images on a display of an electronic device comprises the following steps:
providing an input device as described above,
moving the shuttle while sensing the feedback of the shuttle to the user depending on the position of said shuttle,
releasing the shuttle upon reaching a pre-determined position.

The user may also monitor the display, wherein the step of releasing of the shuttle is provided upon reaching a pre-determined cursor position or a pre-determined image. The further step of activating a sensor upon the shuttle reaching a pre-determined position may be provided.

The input device according to the following examples shown is able to provide multiple functions simultaneously, such as the functions of a keyboard, of a scrollwheel, of a D-pad, or those of a computer mouse. It may provide intuitive manipulation of a cursor on a screen by moving a shuttle in substantially the same directions as the intended moves of the cursor. It may provide improved visual feedback to the user. Further possible but not necessary advantages of the examples may include among others: it provides low-cost, highreliability, and kinesthetic feedback; provides low power consumption by non-haptic detent systems; provides a small and substantially flat form that fits on the front panels of PDAs, mobile phones, wristwatches, and the like; supports blind and non-blind operation; can be operated with one hand or two hands; can be operated with one or more user thumbs or fingers; can be operated while being supported against gravity by user hands, while being attached to a user body part such as a hand or a finger, while being embedded into a firm stationary object such as a TV control panel, or while being embedded into a moving part connected to a firm object such as a joystick connected to a console; lends itself to rapid actuation by requiring a smaller finger or thumb trip than other existing solutions; provides improved accuracy by optionally snapping to predetermined positions; avoids misplacement of parts by keeping all its parts and components secured together during operation and idle time; provides an ergonomic nearly stationary position of the user fingers and hands by allowing reduced finger travel without compromising accuracy; lends itself to robust rugged implementations by protecting the internal areas under a cover; is capable of being implemented

within a small volume by ensuring that all its mechanical components execute gliding movements wherein each said component remains contained into a substantially superficial volume wherein each point of said volume is within a small distance from a fixed surface. Said gliding movement may be for example a translation, rotation, or combination thereof.

The following examples may provide improved control of movement of a cursor in a two-dimensional image on an electronic display, improved shifting and switching of a viewable area in said two-dimensional image, improved text, data, and command input, improved menu, icon, window, and hypertext navigation and selection, a multispeed two-dimensional cursor control and viewable image control, and improved input for computer and video games.

The device comprises a thumb or finger-engaged shuttle, which can be pad-shaped, which executes gliding movements in two directions causing a cursor to move on a display. Two optional detent systems provide kinesthetic feedback and a snapping to grid effect, similar to moving a finger over a grid or a mesh. The detent systems can be set by the user to be active or inactive, thereby enabling the finger to stop easily at recesses of the grid or mesh.

The input device also comprises optional depressable sensors, optional extension sensors actuated by pushing the shuttle at the extreme locations of gliding movement, and, optionally, the shuttle itself is clickable.

A sensor is often but not always a button or a lever which is capable of being depressed by applying a force substantially orthogonal on the area that comes in contact with the user member, often providing a kinesthetic and acoustic feedback when switching to a depressed state, and reverting to a non-depressed state when the said force is no longer being applied. Often the force-displacement graph of an actuated sensor is highly non-linear in the area where the click occurs. Methods for text input, image scrolling and shifting, cursor control and navigation are disclosed wherein the cursor travels or the viewable area of an image shifts according to moves of the shuttle, and cursor or image steps ahead by a preset increment in response to depressing the extension sensors which may be larger in response to depressing. Systems are also described consisting of said input device and a host such as a computer, a mouse, a keyboard, a mobile phone, a personal digital assistant, a media player, a remote control, or said input device embedded into another input device such as a mouse or a keyboard.

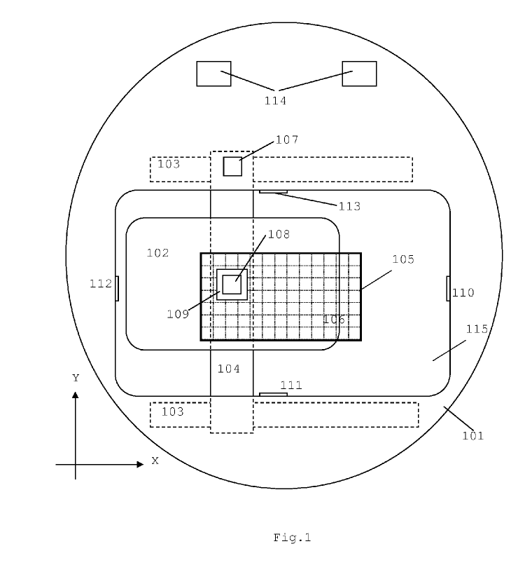

One aspect of the present application is a device for providing input by means of digital electronic signals, hereinafter referred as the ‘input device’, as described in FIG. 1, comprising a housing 101 preferrably made of a rigid material such as polycarbonate, ABS plastic, metal, wood, or the like, a movable member—hereinafter the shuttle 102—, an optional virtual grid—hereinafter the grid 106—of locations for the shuttle, an optional detent mechanism—hereinafter the detent—, a movement sensing mechanism—hereinafter the sensors 107, 108—, optional sensors, and a controller.

The shuttle 120 is capable of being engaged by the user to execute gliding movements in two directions—directions X and Y in FIG. 1—. The two directions are at an angle with respect to each other, which can be a right angle.

The said input device further comprises a still part of a first gliding assembly (103) and a still part of a second gliding assembly (104).

Grid 106 comprises non-overlapping areas located inside the area spanned by the movement of the shuttle. The nonoverlapping areas are hereinafter called shuttle locations. Area spanned by movement of the shuttle is hereinafter called shuttle span 105.

The detent is capable of providing kinesthetic feedback to the user when the user engages the shuttle to travel from one shuttle location to another. Said kinesthetic feedback may be purely passive, meaning that said detent does not necessarily use any active or haptic components to generate user sensations such as said kinesthetic feedback and the source of energy for the movements comprised by said feedback is the forces applied by the user to engage the shuttle. This passive feedback solution provides for high reliability, low manufacturing cost, and low power consumption compared to an active feedback solution that comprises motors or other actuators. An example of such detent system is the spring and gearwheel Mechanism comprised in the scroll wheel encoders 1601 in FIG. 16, Which are affixed to said housing, and connected to the moving parts of first and second gliding movement assemblies by means of rods and joints systems.

In one embodiment, the said detent systems further comprise a snapping mechanism (FIG. 27A, 27B, 27C, 27D). The snapping mechanism comprises two parts, call them slider and base. The base comprises gear teeth (2705) on a straight rail affixed to the base. The slider may comprise a spring (2703) that pushes in between the gear teeth (2705) of the base gear rail (2705). In effect, the snapping mechanism ensures that the slider always moves towards stable positions relative to the base, where the spring extends maximally in between two consecutive teeth.

The said detent system may further comprise a mechanism for enabling and disabling snapping (2704). Snapping is enabled when the spring (2703) engages with the gear teeth (2705) as described above. Snapping is disabled when the spring is disengaged from the gear teeth (2705). To disengage the spring from the gear, the spring (2703) is brought to a compressed position in which the spring cannot reach the teeth regardless of the relative position of the slider and the base. To bring the spring (2703) to this compressed position, a collar (2704) that encircles the spring and an inflexible rod (2702) is progressively moved over the spring to compress the spring, and the collar is latched to hold the spring. The rod, spring and collar are fixed together in one point on a bracket (2701).

Those skilled in the art will appreciate that other means can be provided for implementing said detent systems, including detent systems that contain active and haptic feedback components, combinations of active and passive components, configurable detent parameters that can be changed prior to usage, and adaptive or programmable detent parameters that can be changed during usage.

The present application comprises detent mechanisms for providing kinesthetic feedback in the form of a snap to a predetermined position. FIG. 26 represents the said kinesthetic feedback by describing the dependency of the force provided by the detent mechanism to the shuttle. In one embodiment, at each position on the horizontal axis the detent mechanism applies a force equal to the vertical distance to the plot. In FIG. 26, the convention is adopted that if the said distance is positive, the said force is towards the right; if the said distance is negative, the said force is towards the left. The overall effect is that the circles represent positions of the shuttle: the blank circles represent unstable equilibrium whereas the dark circles represent stable equilibrium. FIGS. 26 (a) and (b) represent two of the possible forms of the said dependency. Similar kinesthetic feedback will be generated by said detent mechanisms in response to movements of said shuttle in a second direction. In general, the force of the said kinesthetic feedback may be dependent not only on the position of the shuttle in one direction but also on the position of the shuttle in a second direction. The force feedback can be the gradient of a smooth surface whose lowest points are the stable equilibrium positions of said shuttle.

Optionally, the detent is capable of being configured by the user to be active or inactive during the move of shuttle. This configuring may be realized by applying a vertical force on the shuttle that is different—substantially larger or substantially smaller—than the vertical force needed to depress the optional vertical sensor, or Further by depressing an optional on/off sensor or by changing the state of an optional N-state sensor on said input device.

The movement sensing mechanism is capable of determining the amount of displacement of the shuttle in each of the two directions.

Sensors comprise optional click sensors, extension sensors, and vertical sensors. Said optional click sensors (114) are capable of being depressed by the user pushing the sensors.

Optional extension sensors (110, 111, 112, 113) are capable of being depressed by the user pushing the shuttle in one of two directions of movement while the shuttle is located at an extremity of the shuttle span.

Optional vertical sensors (109) are capable of being depressed by the shuttle by pushing the shuttle or a part of the shuttle in a third direction where in third direction is at an angle with two directions of movement of shuttle, which may be a right angle.

Optionally, the shuttle is comprised of an inner shuttle that glides along the longitudinal rod, an outer shuttle that is touched by the user, and a connecting rod that is affixed to both inner and outer shuttles. The movement sensing mechanism is optionally protected by a cover 115 affixed to the housing 101. The outer and inner shuttles may completely conceal an opening through the cover through which protrudes the connecting rod. Optionally, the said input device comprises a seal, boot, or flexible membrane attached to cover 115 which may also be attached to the shuttle or said connecting rod so that it insulates the movement sensing mechanism from the exterior of the housing so that humidity and dirt cannot enter the movement sensing mechanism.

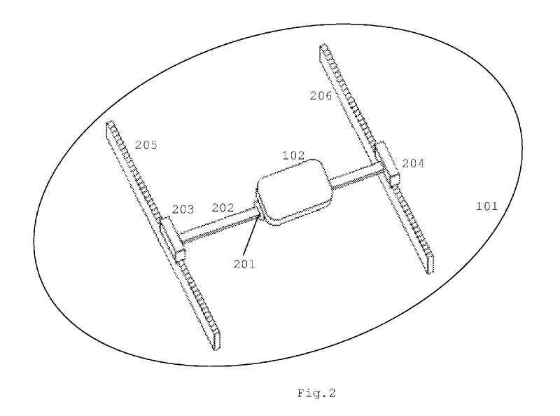

The present application further comprises a controller which is communicatively connected to movement sensing mechanism and click, extension and vertical sensors. The controller is configured to generate electrical signals to indicate the occurrence and amount of displacements. In FIG. 2 the movement sensing system may comprise a hollow channel 201 in the shuttle 102 in which there is a rod 202 that permits the movement of the shuttle alongside the rod but does not permit the movement of the shuttle laterally with respect to the rod. The rod may have a substantially rectangular cross section but said rod may also have any shape that prevents, hinders or even reduces a rotation movement of the shuttle around the rod. At the two ends of the rod there are two bodies secured to the rod, hereinafter sliders 203 and 204, for guiding the movement of the rod relative to housing. Each slider is capable of gliding on a rail, there may also be a different rail for each slider, 205 for slider 203 and 206 for slider 204, wherein the rail is affixed to the housing 101 and wherein the assembly consisting of the two sliders and the rod is preferably rigid and assembly is capable of a gliding movement along side the rails.

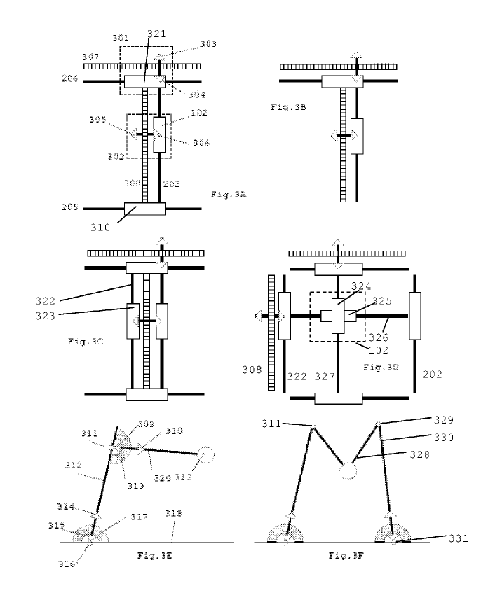

As shown in FIG. 3A, an embodiment of the movement sensing system comprises a first sensor 301 for determining the position of the shuttle 102 alongside the rod 202 and a second sensor 302 for determining the position of the rod 202 alongside the rails 205 and 206. Sensors 301 and 302 preferably comprise a light source—303 for first sensor 301 and 305 for second sensor—and light detector—304 for first sensor 301 and 306 for second sensor—affixed to the moving part—the shuttle for the first sensor and the rod for the second sensor—and a fin—307 and 308—preferably of elongated rectangular shape wherein the fin is affixed to the still part—the rod for the first sensor and one of rails for the second sensor—and wherein the fin is oriented substantially alongside still part and wherein the fin is positioned in between the light source and the light detector so that blades on the fin periodically obstruct the light beam from the light source to the light detector when the moving part is engaged in a gliding movement relative to the still part.

In a further embodiment, elements 205, 206, and 307 of FIG. 3A are curved in a vertical plane orthogonal on the figure plane, while elements 202 and 308 are straight so that the surface spanned by the shuttle is substantially cylindrical, curved around a transversal axis. In another embodiment, elements 202 and 308 are curved and elements 205, 206 and 307 are straight so that the surface spanned by the shuttle is substantially cylindrical curved around a longitudinal axis, as shown in FIG. 23. In an embodiment elements 202 and 308 are curved with a first radius and elements 205, 206 and 307 are curved with a second radius so that the shuttle spans a curved surface.

The mechanism in FIG. 3A can be extended or simplified as a tradeoff between complexity of the mechanism and its usability properties. The mechanism shown in FIG. 3B is obtained by using only the following elements from FIG. 3A: 307, 321, 206, 304, 303, 308, 310, 202, 102, 306, 305. The operation of the mechanism in FIG. 3B is substantially the same as in FIG. 3A, but the mechanism is simplified. The mechanism shown in FIG. 3C is obtained by adding the following elements to FIG. 3A: rod 322 and gliding element 323 ensure better stability of the shuttle 102. The operation of the mechanism in FIG. 3C is substantially the same as in FIG. 3A. In the mechanism of FIG. 3D, the elements 202, 322, and 308 of the second gliding assembly are affixed to the housing instead of being affixed to the moving elements of the first gliding assembly.

The mechanism in FIG. 3D comprises the elements of FIG. 3C and further comprises rod 326 capable of moving longitudinally (up-down in FIG. 3D) and rod 327 capable of moving transversally (left-right in FIG. 3D) and two crossed gliding elements 324 and 325 wherein each said gliding element further comprises a hollow shaft allowing a rod to move through said gliding element: 324 moves along rod 327 and 325 moves along rod 326. Since 324 and 325 are affixed to each other, the assembly comprising 324 and 325 forms a shuttle 102 capable of two dimensional movement. The mechanism in FIG. 3F comprises the elements of FIG. 3E and further comprises rods 328 and 330 and joints 329 and 331, and one of the two rotational sensor systems has been moved to joint 331 instead of joint 311. It will be apparent to those skilled in the art that detent mechanisms such as the linear mechanism in FIG. 27, or an assembly consisting of gears and wheel encoders, can be utilized to ensure a step movement rather than a continuous movement of each gliding assembly.

In FIG. 3B-3F are described embodiments of movement sensing system. In FIG. 3E, joint 316 is affixed to console 318 and rod 312 so that rod 312 can execute a rotation movement in a plane. Fins 317 are affixed to console 318; light source 315 and light detector 314 are affixed to rod 312 so that, as rod 312 rotates, the light from source 315 is intermittently obstructed by the fins in 317 and light detector 314 generates electrical impulses encoding the angle between 312 and 318. Joint 311, capable of rotation in a plane, is affixed to rod 312 and rod 320 so said rods 312 and 320 may form a variable angle but remain in a plane at all times. Fins 319 are affixed to rod 312; light source 309 is affixed to rod 320 and light detector 310 is affixed to rod 320 so that when the angle between 312 and 320 varies, the light from 309 is intermittently obstructed by fins 319 and detector 310 generates electrical impulses encoding the angle of 312 and 320. Thus, as the user member engages pad 313, the position of the pad is uniquely determined by the impulses from the light detectors since these impulses encode the two said angles which uniquely determine the position of said pad.

The rods 320 and 312 can also be arcs of circles with the same radius so that the rods remain embedded in the surface of a sphere at all times.

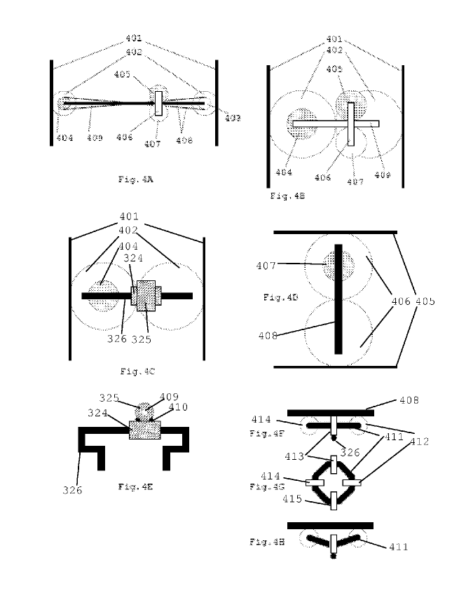

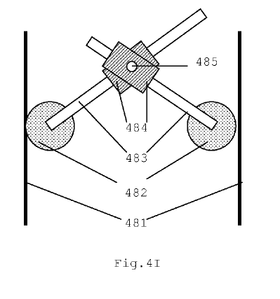

A further embodiment of the movement sensing system is described in FIG. 4A and comprises two gliding movement assemblies wherein each gliding movement assembly comprises a still part and a moving part. The still part 401 of a first gliding movement assembly—hereinafter first assembly—is affixed to the housing, the still part of the second said assembly—hereinafter second assembly—is affixed to the moving part of first assembly, and the shuttle 406 is affixed to the moving part of second assembly. The two assemblies are positioned so that the moving parts of the two assemblies can only execute gliding movements that are at an angle with respect to each other, preferably at a right angle. The still part of first assembly 401 comprises two rails. The moving part of first assembly comprises two gear wheels 402 that are positioned substantially within the plane of the rails, wherein each gear wheel also gears with one rail. Further a mechanism such as a gear belt or bending axle or toothed belt 408 ensures that the gear wheels maintain an equal distance from each other and turn at the same rate, thus ensuring that the two gear wheels advance along the gear rails at the same rate producing an overall gliding movement of the moving part of the first assembly with respect to the housing. In this embodiment two gears wheel 403 and 404 are provided to gearing with toothed belt 408 and to ensure an gliding movement of the moving part of the first assembly with respect to the housing. The second assembly has the same structure as the first assembly but with possibly different dimensions. The still part of second gliding assembly comprise a gear rail 409. Further, the still part of either of the assemblies may comprise a single rail instead of two rails (FIG. 3B), and optional wheels (405, 407) to reduce friction between moving and still parts (FIG. 4A). Further, either assembly may comprise a still part comprising a joint and a moving part comprising a bar capable of a turning movement in an arc centered at the joint. Optionally, each assembly comprises a detent system that ensures that the moving part can only move at preset increments with respect to the still part.

FIG. 4C and FIG. 4D show two gliding assemblies for transversal and longitudinal movements of a shuttle. The first gliding assembly, shown in FIG. 4C, comprises gear rails 401 affixed to a housing and gear wheels 402 wherein said gear wheels are capable of gearing each other and the gear rails while gear wheels move longitudinally (up-down in FIG. 4C). Bent rod 326 serves as axle for the gear wheels 401 and for a rotational wheel encoder 404. Said wheel encoder has an outer surface affixed to the gear wheel underneath said wheel encoder in FIG. 4C and a hollow shaft affixed to said bent rod, wherein said wheel encoder is capable of sensing the rotational angle of said gear wheel. Said wheel encoder may further comprise a detent mechanism capable of providing a step movement wherein the movement is biased towards certain rotational angles. The gliding elements 324 and 325 are affixed to each other by means of adhesive 410 in FIG. 4E and said gliding elements further comprise hollow shafts such as 409 in FIG. 4E. The bent rod 408 of FIG. 4D goes through the hollow shaft 409 of gliding element 325 and the bent rod 326 goes through a substantially similar hollow shaft of gliding element 324. In effect, the gliding assemblies of FIG. 4C and FIG. 4D are stacked on top of one another and permit longitudinal and transversal movements of the shuttle comprising 324 and 325.

To reduce friction of the shuttle against said rods, FIG. 4F and FIG. 4G show a shuttle comprising a bent axle 411 and wheels 412, 413, 414, 415. Wheels 414 and 412 run on rod 408 and wheels 413 and 415 run on rod 326. FIG. 4H shows that the bent axle 411 is capable of ensuring any elevation of said wheels by bending the said axle outside a plane shape.

A further embodiment of the present application is shown in FIG. 4I. Wheel encoders 482 are affixed to housing 481 and permit rods 483 to execute rotational gliding movements about the rotational axes of the wheel encoders. Each said rod further comprises a hollow shaft cuff 484 capable of executing translation gliding movements along the respective rod. Hollow shaft cuffs 484 are affixed to each other by a joint that permits rotational movement so that said shafts form a variable relative angle while remaining attached and forming a shuttle capable of being engaged by a user thumb or finger. Sensors such as 485 may be affixed to said shuttle and capable of being engaged and depressed by a user thumb or finger.

The movement sensing system can also comprise two gliding movement assemblies wherein each gliding movement assembly comprises a first joint that is affixed to the housing, a first bar that is affixed to the joint wherein the bar is capable of a turning movement in an arc centered at the first joint, and a second bar that is affixed to the joint wherein the bar is capable of a turning movement in an arc centered at the second joint. The free-moving ends of the second bars of the two moving parts are joined by a joint to which said shuttle is attached (FIG. 3F).

The sensors may be implemented by an encoder assembly such as the EC10E hollow shaft type encoder sold by the Alps company of Japan and described in U.S. Pat. No. 6,392,168. It has either a resolution of 12 or of 24 positions through a 360° revolution. The moving part of gliding movement assemblies comprises a turning component connected by a movement conversion mechanism to the rest of the moving part wherein the turning component is capable of a turning movement at an angle substantially proportional to the amount of displacement of the moving part, wherein the inner part of the hollow shaft of the encoder is attached to the turning component of the moving part of the gliding movement assembly and the outer part of the encoder is attached to the still part of the gliding movement assembly. The movement conversion mechanism may consist of gears, rod and crankshaft, or any mechanism capable of converting gliding movement to a turning movement substantially spanning an arc. Further, the sensors are affixed to the housing and the sensors are actuated by rods and joints mechanisms that ensure the inner channel parts of the sensors turn at a rate substantially in proportion to the rate of the gliding movements of the moving parts of the assembly (FIG. 16).

It will be apparent to those skilled in the art that mechanisms can be used to convert gliding movements of a finger-engaged pad on a plane or other two dimensional surface into rotational movements of the hollow shaft of two wheel encoders as illustrated in FIG. 4.

A further aspect of the present application is a system comprising a computer mouse ball capable of being engaged by the user finger or thumb, two cylinders attached to the housing that engage with the ball by friction, and two incremental wheel encoders attached to the cylinders wherein each wheel encoder comprises a detent system wherein each wheel encoder encodes the rotational movement of one of the said cylinders. The effect of the said system is a snap movement in two dimensions realized by engaging the ball with a user thumb or finger.

The shuttle may be shaped substantially as a flat pad wherein the thickness of the pad is substantially smaller than the transversal and lateral sides of the pad.

The shuttle may be shaped as a stick, knob, pyramid, cone, joystick, or any shape or combination of shapes that provides a good grip for the user finger, thumb or hand to engage the shuttle in the transversal and longitudinal gliding movements and vertical depressing movements.

Optionally, the shuttle may comprise anti-slip features such as rubber coating or grooves on the side of the shuttle that comes in contact to the user finger or thumb during operation.

The shuttle span may be shaped as a flat rectangle or square surface but the shuttle span may optionally be shaped as a fragment of a concave or convex curved surface, such as a substantially spherical or cylindrical surface, wherein the shuttle is also shaped substantially as a smaller fragment of curved surface to enable the shuttle to execute gliding movements in two directions on the shuttle span surface. Examples of curved shuttle and span surfaces are shown in FIG. 23 and FIG. 24. In FIG. 23 the said surfaces are cylindrical and in FIG. 24 the said surfaces are spherical. The benefits of a curved surface include a more ergonomic fit to a holding user member—the user index finger to which the ring is attached in FIG. 23—or to the movement of an engaging user member—the user index finger that engages the shuttle on the mouse of FIG. 24—, compared to a flat surface. The mechanics of a gliding movement in the curved surfaces are implemented by embodiments as illustrated in FIG. 4.

The shuttle is preferably made of a firm solid material but the shuttle may further be made of a flexible material or of a body with hinges and springs to enable the shuttle to fit closely to the span surface during movement of the shuttle.

In a further embodiment, the present application comprises a mouse ball engaging with cylinders connected to rotational sensors wherein said cylinders are capable of rotational movements around their axes with optional detent systems capable of causing said cylinders to snap to predetermined rotational angles.

A further example of the present application comprises a joystick mechanism with detent systems and wheel encoders.

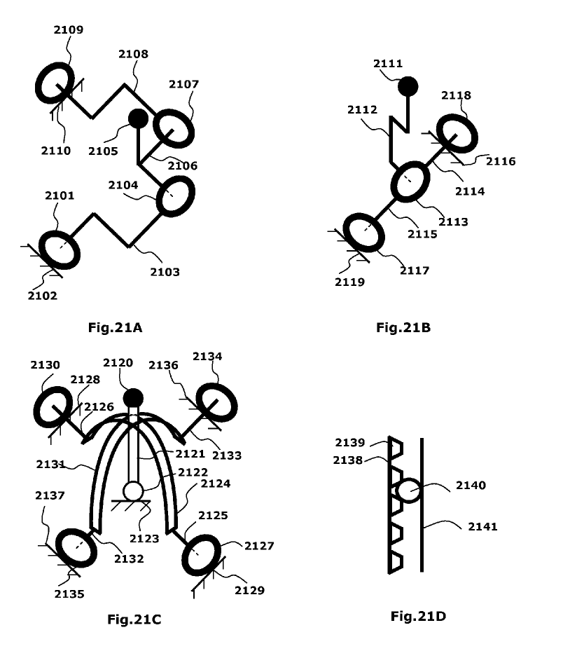

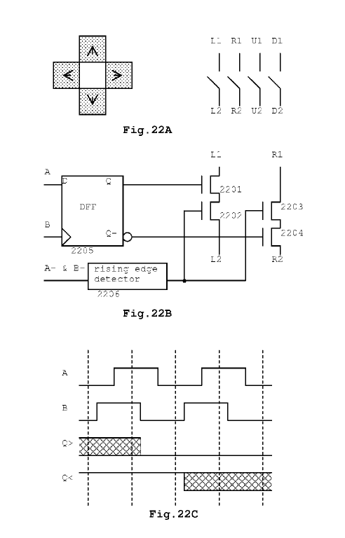

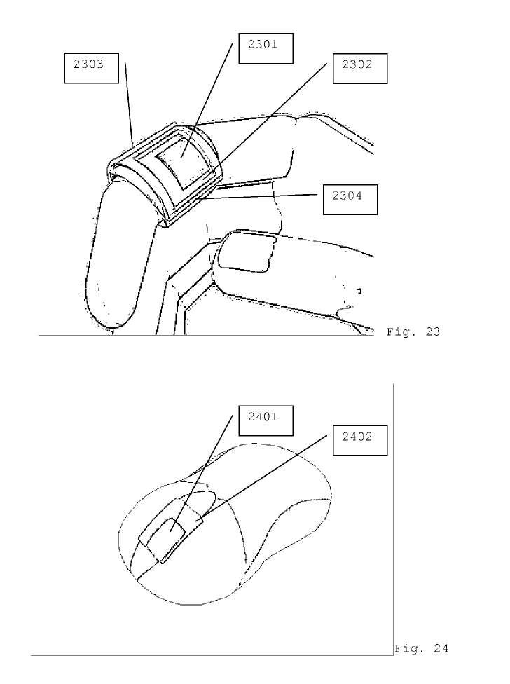

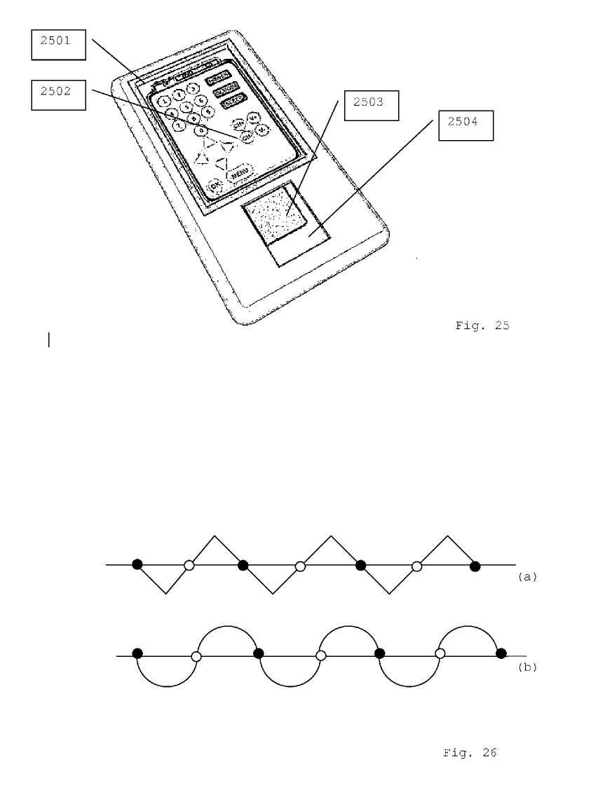

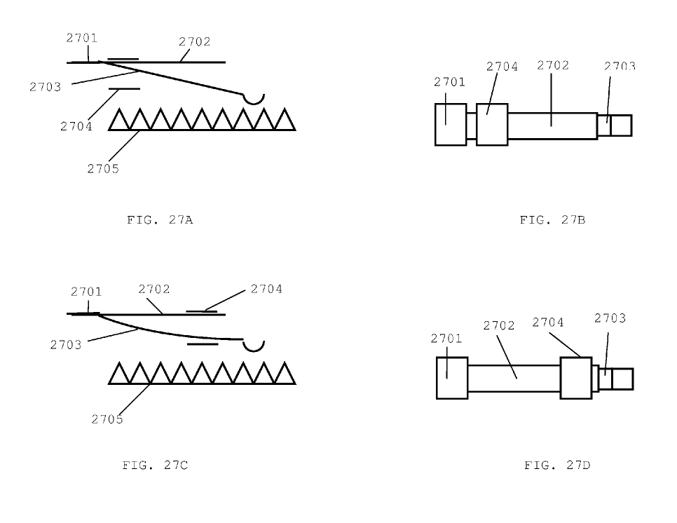

In one embodiment, illustrated in FIG. 21A, hollow shaft wheel encoders with detent systems 2101 and 2109 are affixed to the housing parts 2102 and 2110, respectively. The housing parts are affixed to the housing, and being affixed means maintaining a rigid stationary relative position. Rigid arm 2108 is capable of executing a rotational movement by the axis of the hollow shaft of encoder 2109. Rotational joint 2107 is affixed to 2108 and comprises a hollow shaft. Rigid arm 2106 is capable of executing a rotational movement by the axis of the hollow shaft of 2107. Rigid arm 2103 is capable of executing a rotational movement by the axis of the hollow shaft of encoder 2101. Rotational joint 2104 is affixed to 2103 and comprises a hollow shaft. Rigid arm 2106 is capable of executing a rotational movement by the axis of the hollow shaft of 2104. Blob 2105 is affixed to rigid arm 2106 and is capable of being engaged by a user member such as a finger or thumb to execute a two-dimensional movement capable of snapping to predetermined positions according to the stable rotational angles of the detent systems comprised in 2101 and 2109.

In another embodiment, illustrated in FIG. 21B, wheel encoder with detent system 2117 and rotational joint 2118 comprise hollow shafts with the same axis and are affixed to housing parts 2116 and 2119 which are affixed to the housing. Rigid arms 2115 and 2114 are capable of a rotational movement by the axis of the hollow shafts of 2119 and 2118 and are affixed to wheel encoder with detent system 2113. Rigid arm 2112 is capable of a rotational movement around the hollow shaft of 2113. Handle 2111 is affixed to 2112 and is capable of a rotational movement in two dimensions and snapping to predetermined positions according to the stable rotational angles of 2113 and 2119.

In another embodiment, illustrated in FIG. 21C, the detent systems reside in rail guides (2124, 2131) instead of rotational joints. Rotational joints 2130, 2135, 2134, and 2127 are affixed to housing parts 2128, 2136, 2129, 2137 which are affixed to the housing. Rigid arms 2132, 2133, are capable of rotational movement by the common axis of the hollow shafts of 2135 and 2134, and rigid arms 2125 and 2126 are capable of rotational movements by the common axis of the hollow shafts of 2127 and 2130. Rail guide 2131 is affixed to 2132 and 2133 and rail guide 2124 is affixed to 2126 and 2127. Ball joint 2122 comprises a still part and a moving part, wherein the said parts are capable of two dimensional rotational movement relative to each other. The said still part is affixed to housing part 2123 which is affixed to the housing. The said moving part is affixed to rigid arm 2121 which is affixed to the handle 2120 which is capable of being engaged by a user member. A user member may be a palm, finger, thumb, tongue, or the like. In a further embodiment, at least one of the rails in each of the said rail guides is flexible, and at least one rail in each said rail guide further comprises gear teeth of a triangle, trapeze, rectangle or rounded shape that cause the rigid arm 2121 (2140 cross section) to snap to predetermined angular positions relative to the respective guide. When the user engages the handle 2120 in a longitudinal or transversal direction along one of the rail guides, the rigid arm 2121 pushes along the rails of the respective guide overcoming the resistance of the gear teeth in the respective guide due to flexibility of the rail, and snapping to predetermined positions along the respective guide. The user may engage the said handle—joystick—along both guides simultaneously providing a snap effect in each guide.

The said joystick mechanisms in FIG. 21A-C may further comprise extension sensors capable of sensing when the said joystick rigid arm affixed to the handle reaches extreme positions in either one of its two dimensions of rotational movement—in other words, said extension sensors are clickable when the handle reaches one of the four edges of the surface spanned by the movements of the handle, for example by being depressed by the joystick rigid arm when said arm reaches extreme positions of the rotational joints. It will be apparent to those skilled in the art that different configurations of encoders, detent systems, joints, arms, and sensors can be used to achieve the effect of a joystick snapping to predetermined positions; for example, the roles of 2109 and 2107 can be swapped, the encoders may reside in different joints than the detent systems in FIG. 21A and FIG. 21B, the detent systems may reside in the rotational joints instead of the guides in FIG. 21C, and the shapes of the rigid arms can be different from the shapes shown in FIG. 21A-C. In another embodiment, the encoders or detent systems are placed on rotational joints affixed to the joystick rigid arm 2121 in FIG. 21C wherein the said rotational joints are capable of engaging the gear teeth or a friction mechanism on the guide rails to cause a rotational movement of the rotational joints relative to the joystick and to cause the joystick to snap to predetermined positions by providing a force bias towards predetermined stable rotational angles of the rotational joints. Said extension sensors may be affixed on the joystick rigid arm, other rotating rigid arms, or on the housing itself.

It will be apparent to those skilled in the art that multiple gliding assemblies can be used to support movement in each single direction. For example, the original assembly comprising pieces 104, 107, 108, and 109 can be replicated and connected to the shuttle and the rails 103 such that the replicated assembly executes a gliding movement in parallel to the gliding movement of the original assembly.

It will be apparent to those skilled in the art that combinations of gliding assemblies can be used to achieve movement in different directions. For example, the gliding assembly for the first direction can comprise the pieces 104 and 107. The gliding assembly for the second direction can

comprise the pieces 2113 and 2112, wherein 2113 is affixed to 104.

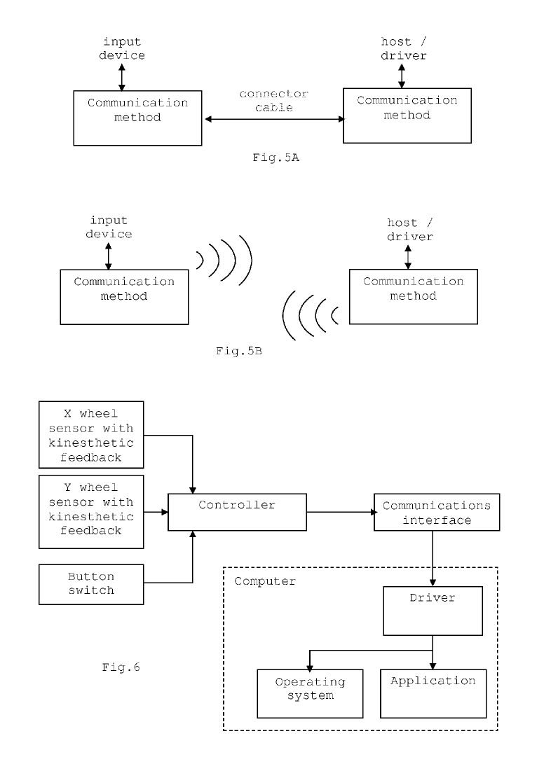

A further example of the present application provides an electronic input system, illustrated in FIG. 6, comprising one or several of the said input devices, a communications interface communicatively connected to the said input devices and capable of conveying signals from the said input devices to an electronic device—hereinafter called host. The host is communicatively connected to a communications interface and capable of processing the signals generated by the said input devices, and a display communicatively connected to the host and capable of changing the image displayed on the display in response to the signals. The host may be a computer, a telephone handset, a mobile telephone, a personal digital assistant, a global positioning system, a media player such as the iPod sold by Apple Computer Inc., of Cupertino, Calif., USA, a digital camera, a video recorder, a gaming pad such as the Xbox sold by Microsoft Corp. of Redmond, Wash., USA, a joystick, a control panel, a remote control, a watch, and the like. Optionally, said input devices may be secured to the host or may be built into the same housing as host or as part of the host. The communications interface may be a wired or wireless interface. A wired interface preferably comprises for each said input device an output port of said input device, an input port of the host, a connector cable communicatively connected to the output port and input port, preferably conforming to a communications standard such as USB—Universal Serial Bus—or PS2 as showed in FIG. 5A. A wireless interface preferably comprises for each said input device an output port of said input device and an input port of the host capable of communicating to the output port via a wireless communication protocol such as Bluetooth, WiFi, or a protocol that uses infrared radiation as communication medium as showed in FIG. 5B.

The host may comprise a driver software component running on the host wherein said driver software component is capable of receiving the signals from the said input device via the communications interface and providing events to software applications and operating system running on the host wherein the events indicate the occurrence of the shuttle movements and amount of displacement of the shuttle movements and occurrence of depressed state of the sensors. The software applications and operating system running on the host can be capable of receiving and interpreting the events and are further capable of changing, shifting, or modifying the image displayed on the display in response to the events.

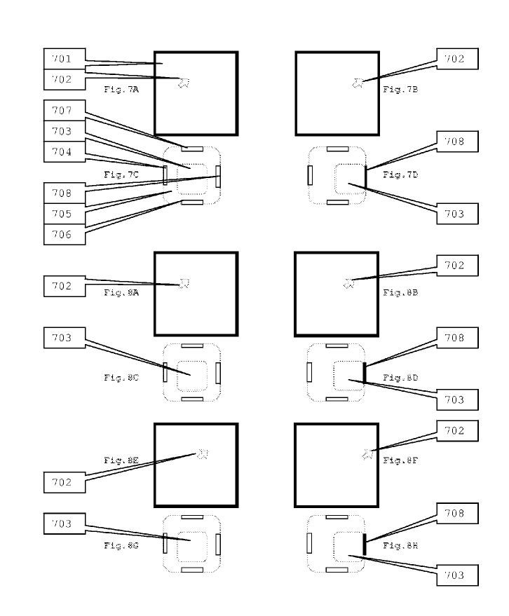

FIG. 7A,B,C,D show elements of a method for providing input information into a host capable of processing said information wherein said host comprises a computer, phone, or the like. FIG. 7A shows a digital display 701 of said host wherein the image being displayed on said display further comprises cursor 702 wherein said cursor is capable of being moved laterally and transversally within said image. FIG. 7C shows the user interface of an input device comprising shuttle 703, housing 705, and extension sensors 704, 706, 707, and 708 wherein shuttle 703 is capable of being engaged by a user member to execute lateral and transversal movements within a range of movement spanning housing 705. Said cursor executes movements in substantially the same direction as said shuttle: if the shuttle moves up, the cursor moves up; if the shuttle moves down, the cursor moves down; if the shuttle moves left, the cursor moves left; if the shuttle moves right, the cursor moves right.

Said sensors 704, 706, 707, and 708 are capable of sensing whether said shuttle reaches the extremes of said range of movements 705. Said sensors may be implemented as depressible buttons, touch surfaces, optical sensors, and the like. FIG. 7D shows the situation where shuttle 703 has reached its rightmost position and shuttle 703 depresses the sensor 708 wherein sensor 708 is a depressible sensor.

In one embodiment of said method for providing input, depressing one of the said sensors causes said cursor to execute repeated movements substantially in the direction of said sensor during the period while said sensor is being depressed. For example, while right sensor 708 is being depressed as in FIG. 7D, the cursor 702 in FIG. 7B executes repeated moves towards the right.

According to a further example of the present application there is a method for graphic image—cursor—manipulation into said system provided wherein said method comprises the following steps: the step of moving the shuttle in one of the two dimensions of movement—FIGS. 7C and 7D illustrate the shuttle position before and after move; the step of moving a graphic image—hereinafter cursor on display by an amount substantially in proportion to the amount of displacement of the shuttle, and preferably in substantially the same direction as the shuttle—FIGS. 7A and 7B illustrate the cursor position before and after movement; the step of the detent system providing kinesthetic feedback to the user when the shuttle travels from one said location to another if the detent is active; the step of the detent biasing the shuttle towards a nearby location in the grid by applying a force substantially opposite to the direction of movement or substantially in the direction of movement, when the shuttle is moving and if the detent is active, and using solely energy accumulated in springs by the user pushing the shuttle.

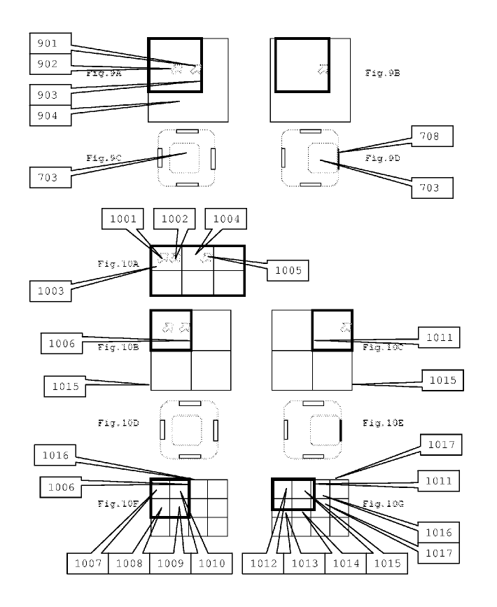

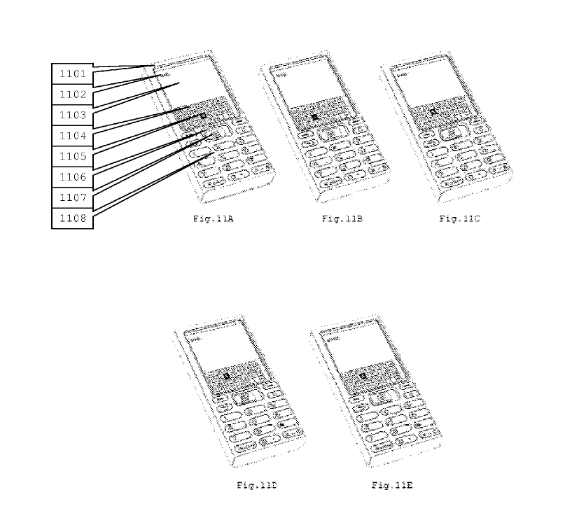

A further example of the present application describes a method for graphic image cursor—manipulation in the said system wherein the method comprises the following steps: the step of moving the shuttle to an edge of the shuttle span—FIG. 8C moving to 8D; the step of moving the cursor on the display by an amount and in a direction corresponding to the displacement of the shuttle—FIG. 8A moving to 8B; the step of depressing the extension sensor located at the edge by pushing the moveable member against the sensor (FIG. 8D); following depressing of the sensor, moves of the shuttle no longer engage the cursor; the step of moving the shuttle away from the edge while the cursor remains stationary—rewind movement—(FIG. 8E, 8G); the step of activating the cursor by depressing another extension sensor, or by depressing the vertical sensor, or by changing or preferably reversing direction of movement of shuttle; the step of moving the shuttle; the step of moving the cursor in response to moving the shuttle (FIG. 8F, 8H); the step of the detent system providing kinesthetic feedback to the user when the shuttle travels from one grid location to another if the detent is active; the step of the detent biasing the shuttle towards a nearby location in the grid by applying a force substantially opposite to the direction of movement or substantially in the direction of movement, when the shuttle is moving and if the detent is active.

In another embodiment of said method for providing input, the act of depressing one of the said sensors causes said cursor to temporarily disengage from movements of the said shuttle, so that the shuttle can be rewound or brought to a previous position without moving the cursor. Further, changes of the direction of movement of said shuttle cause the cursor to reengage, so that the cursor can move further in the direction that the shuttle moves even though the shuttle had previously reached a limit of movement in said direction. For example, the movement towards the right of shuttle 703 from the configuration in FIG. 8C to the configuration in FIG. 8D causes cursor 702 to move towards the right from the configuration in FIG. 8A to the configuration in FIG. 8B. Further, in FIG. 8D sensor 708 senses the shuttle 703 reaching its right limit of movement, causing the cursor to disengage. Further, shuttle 703 moves towards the left from the configuration in FIG. 8D to the configuration in FIG. 8G while cursor 702 preserves its position from FIG. 8B to FIG. 8E. Further, shuttle 703 moves towards the right, thereby changing direction of movement, and it reengages cursor 702 to move towards the right as well. As shuttle 703 moves right from the configuration in FIG. 8G to the configuration in FIG. 8H, cursor 702 moves right from the configuration in FIG. 8E to the configuration in FIG. 8F.

In other embodiments of said method for providing input, the cursor reengages when the shuttle reaches an opposite sensor, when the shuttle is depressed with a higher vertical force, or when another sensor is touched. Moving the shuttle in FIG. 8, 9, 10 comprises the optional detent effects of snapping to fixed positions in a grid and of providing kinesthetic feedback to the user when the shuttle moves by an increment to the next fixed position.

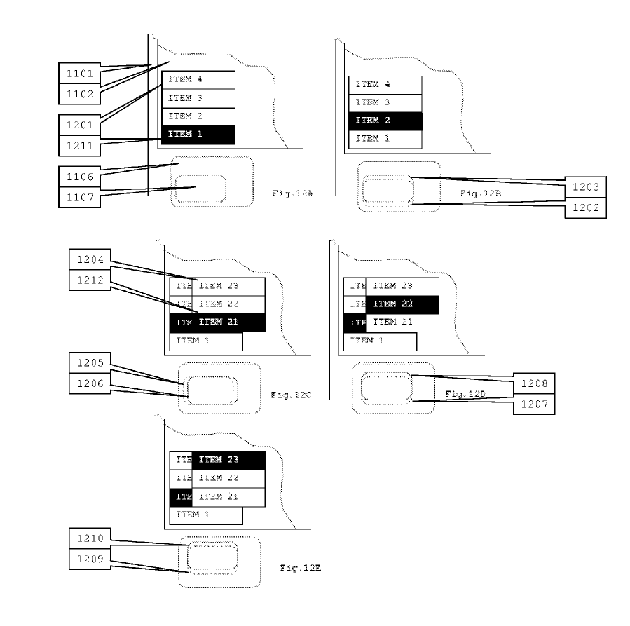

A further example of the present application describes a method for graphic image manipulation in said system wherein the method comprises the following steps: the step of moving the shuttle to an edge of the shuttle span; the step of moving the cursor on display by an amount and in a direction corresponding to the displacement of the shuttle; the step of depressing the extension sensor located at the edge by pushing the moveable member against the sensor (FIG. 9D); the step of shifting the image displayed on the display in response to depressing extension sensor, preferably in a direction away from the edge, thus revealing new—previously hidden from view—graphic content on the display area proximate to the edge (FIG. 9A to 9B); the optional step of repeating the said shifting operation with higher speed if the extension sensors remains depressed after a predetermined period of time—repeat movement; the step of stopping shifting the image once the user ceases to depress the extension sensor; the step of the detent system providing kinesthetic feedback to the user when the shuttle travels from one grid location to another if the detent is active; the step of the detent biasing the shuttle towards a nearby location in the grid by applying a force substantially opposite to the direction of movement or substantially in the direction of movement, when the shuttle is moving and if the detent is active.

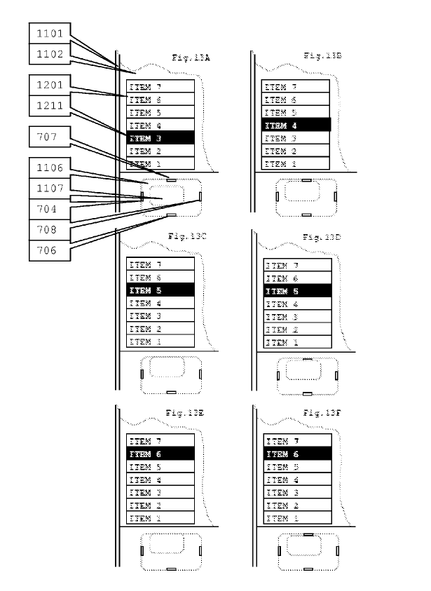

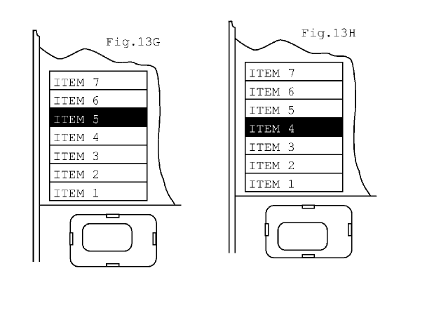

Said method for providing input further comprises the actions to move a cursor within a window and use the extension sensors to move a viewport within a larger viewable image. FIG. 9A shows two possible positions of a cursor 901 and 902 within a frame 903 which delimits a viewport which is a part of a viewable image 904. In one embodiment, the part of the viewable image that is comprised within the viewport is capable of being displayed on a computer display, whereas the larger viewable image is stored within a video card memory. As shuttle 703 moves within range 705 in FIG. 9C, the cursor (901, 902) moves within the viewport 903. When shuttle 703 in FIG. 9D reaches the extreme location on the right, it triggers extension sensor 708 and thereby it moves the viewport to a new location shown in FIG. 9B. In one embodiment, the cursor remains at the same location relative to the viewport in FIG. 9B and FIG. 9A. In another embodiment, the viewport moves to non-overlapping parts of the viewable area when the shuttle triggers an extension sensor as shown in FIG. 10B, 10C, 10D, 10E. instead of moving the viewport slightly on triggering an extension sensor as shown in FIG. 9A, 9B, 9C, 9D.

A further example of the present application describes a method for graphic image manipulation in the system wherein the method comprises the following steps: the step of moving the shuttle to an edge of the span; the step of moving the cursor on display by an amount substantially in proportion to the displacement of the shuttle and in substantially the same direction as the shuttle; the step of depressing the extension sensor located at the edge by pushing the moveable member against the sensor (FIG. 10E); the step of moving the cursor by a predetermined increment in a direction that is substantially the same as the direction of movement from the center of the shuttle span to the edge; the optional step of shifting the graphic image by a predetermined increment in a direction away from the edge if the cursor is located at an edge of display (FIG. 10B to 10C); the optional step of changing the entire graphic image on the display if the predetermined increment is at least as large as the graphic image; the step of the detent system providing kinesthetic feedback to the user when the shuttle travels from one grid location to another if the detent is active; the step of the detent biasing the shuttle towards a nearby location in the grid by applying a force substantially opposite to the direction of movement or substantially in the direction of movement, when the shuttle is moving and if the detent is active.

Said method for providing input further comprises the actions to divide the viewable image into non-overlapping sections such as 1003 and 1004 in FIG. 10A. A cursor moves to different positions within a section of the viewable image (positions 1001 and 1002 within area 1003 in FIG. 10A) by controlling the cursor with the shuttle. The cursor moves to a different section of the viewable image when the shuttle reaches a limit of its range of movement and triggers an extension sensor; for example, in FIG. 10A, the cursor switches from section 1003 to section 1004 on triggering the right extension sensor 703 of FIG. 9C. In one embodiment, switching the section of a viewable area preserves the relative position of the cursor within that section, as shown in FIG. 10A: position 1005 relative to section 1004 is the same as position 1002 relative to section 1003. In another embodiment the viewport may comprise several sections of the viewable image as shown in FIG. 10F wherein viewport 1006 comprises sections 1007, 1008, 1009, and 1010 of the viewable image. In another embodiment the viewport may partly overlap several sections of the viewable image as shown in FIG. 10G wherein viewport 1011 comprises sections 1012-1017 of the viewable image.

Said methods that use extension sensors provide for a multispeed cursor control and viewing area control in a graphical display: low speed, fine grain movements of the cursor or viewing area are controlled by moving the shuttle; higher speed, step ahead movements of the cursor or viewing area are directed by momentarily pushing the extension sensors; highest speed serial step ahead movements of the cursor or viewing area are obtained by depressing and holding the extension sensors in a depress state.

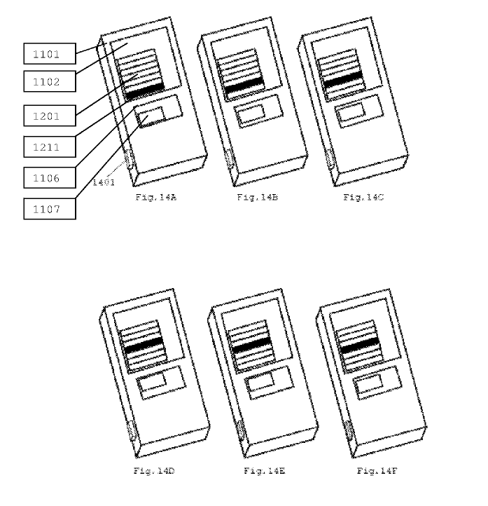

FIG. 11A,B,C,D,E show steps of one embodiment of said method for providing input information into a host system wherein said information consists of typed characters. FIG. 11A shows a host system 1101 comprising a display 1102 and an input device 1106 wherein said input device further comprises a shuttle 1107 capable of being engaged by a user member in transversal and longitudinal movements within the frontal area of 1006. The said display optionally displays a virtual keyboard 1104 and a cursor 1105 within the virtual keyboard. Said shuttle snaps to fixed positions in a two-dimensional grid wherein each grid position corresponds to a location of the cursor on the virtual keyboard. Typing a character comprises the following steps: a selection step wherein the user draws the said shuttle to the grid position corresponding to the desired character, whereas the cursor moves to the desired character in the virtual keyboard; a kinesthetic feedback step wherein the user feels the snapping of the shuttle to said grid position; and a character entry step wherein the user executes a trigger action while the desired character is selected. Said trigger action may comprise depressing the shuttle, triggering a touch sensor, and the like. FIG. 11A-E show examples of selection and typing.

In another embodiment of said method for providing typed characters, no virtual keyboards are being displayed and the user relies on the position of the shuttle and the kinesthetic feedback to determine the next character to be typed. In other embodiments, said host system may comprise alternative input devices such as a mini-keyboard, a scroll wheel, or a physical number pad 1108. Moving the shuttle in FIG. 11 comprises the optional detent effects of snapping to fixed positions in a grid and of providing kinesthetic feedback to the user when the shuttle moves by an increment to the next fixed position.

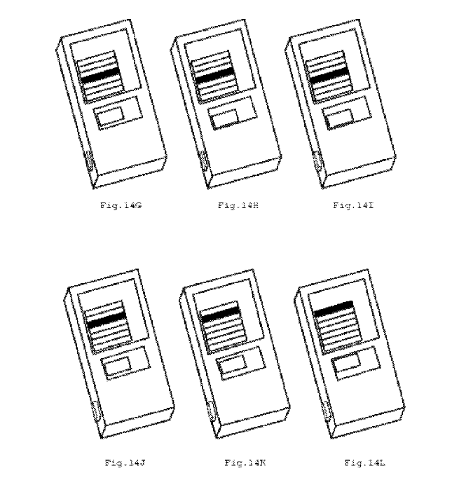

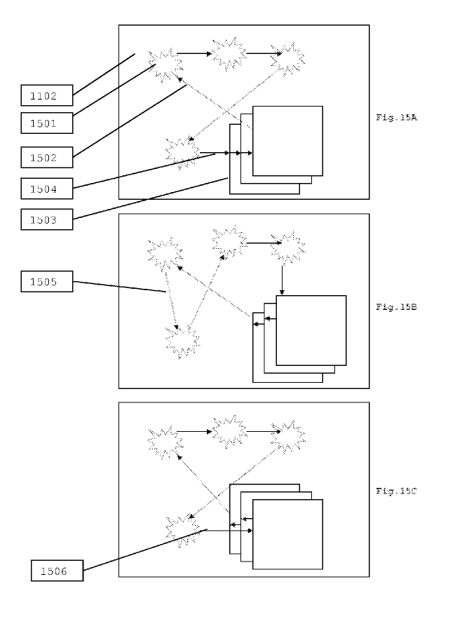

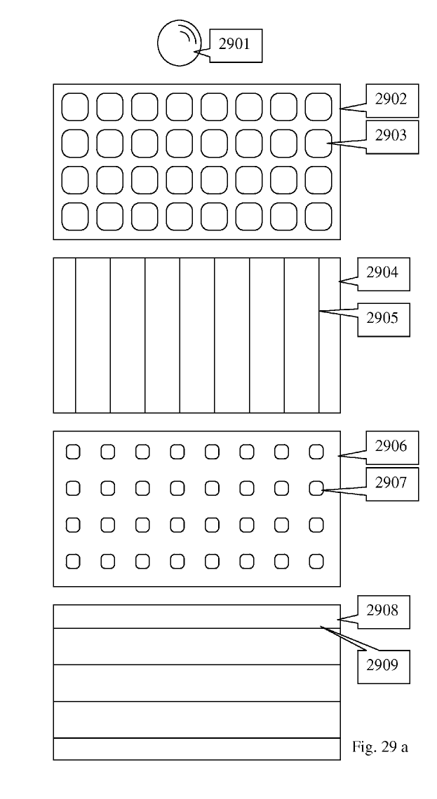

FIG. 12A,B,C,D,E show steps of one embodiment of said method for providing input information into a host system wherein said information consists of selections of menu items. FIG. 25 12A shows said host 1101 comprising display 1102 and input device 1106 wherein said input device further comprises shuttle 1107. A menu 1201 is displayed on said display wherein said menu comprises several menu items (ITEM 1, ITEM 2, ITEM 3, ITEM 4) and a cursor 1211. In FIG. 12B, as said shuttle moves from position 1202 to position 1203, said cursor moves from ITEM 1 to ITEM 2. In FIG. 12C, as said shuttle moves from position 1205 to position 1206, a submenu 1204 appears comprising several menu items (ITEM 21, ITEM 22, ITEM 23) and a secondary cursor 1212. Moving the shuttle back from 1206 to 1205 causes the submenu to disappear and the display to show the display image in FIG. 12B. In FIG. 12D, said shuttle moves from position 1207 to position 1208 and engages the secondary cursor to move to ITEM 22. Further, in FIG. 12E, said shuttle moves from position 1209 to position 1210 and said secondary cursor moves from ITEM 22 to ITEM 23. In effect, the cursor moves substantially in the direction of movement of the shuttle. At any time, the user may trigger an action associated with a menu item by depressing the shuttle, triggering a sensor, etc. In another embodiment, the user may trigger an action associated with a menu item by moving the shuttle to the right akin to opening a submenu.

In FIG. 7, 8, 9, 10, 11, 12, 13, 14, 15, the cursor, shuttle, and sensors are shown in realistic positions corresponding to the configuration of the system at different points in time. Also, the alphabetical ordering of the letters of the figures generally indicates a chronological ordering of the time points of the configurations represented by the respective figures.

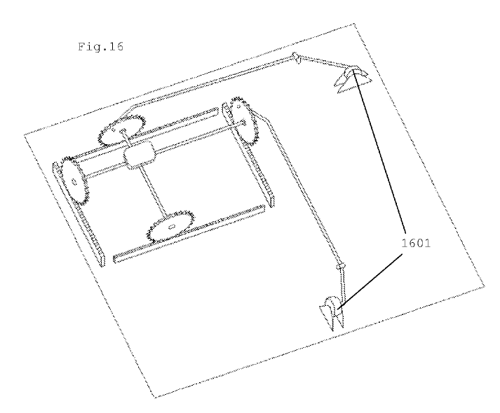

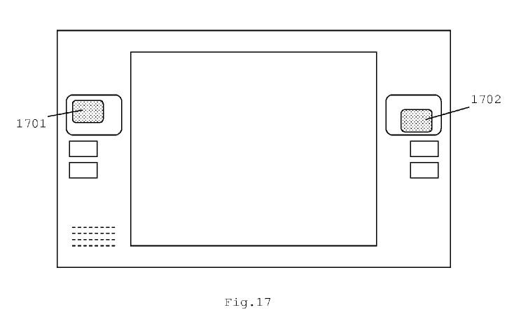

FIG. 13A,B,C,D,E,F,G,H show steps of another embodiment of said method for providing input information into a host system wherein said information consists of selections of menu items. Extension sensors are being used for situations where the cursor needs to be moved beyond the limit of the range of the shuttle.

In FIG. 13A, host 1101 comprises display 1102 wherein said display is showing a menu 1201 comprising ITEM 1 through ITEM 7 and a cursor 1211 located over ITEM 3. The host 1101 further comprises an input device 1106 further comprising a shuttle 1107 capable of transversal and longitudinal movements. The input device 1106 further comprises extension sensors left (704), bottom (706), top (707), right (708) capable of sensing the extreme left, bottom, top, and right positions of the shuttle, respectively. As the shuttle moves up by one snap increment in FIG. 13D, the cursor moves up to ITEM 4. As the shuttle moves up again in FIG. 13 E and triggers the top sensor, the cursor moves up further to ITEM 5. Releasing the sensor as in FIG. 13 F has no effect over the cursor. In FIG. 13 F, the shuttle again triggers the top sensor which causes the cursor to move to ITEM 6. Moving the shuttle down by one increment in FIG. 13 G causes the cursor to move down by one menu item. Moving the shuttle down by one increment in FIG. 13 H causes the cursor to move down by one menu item.

It will be apparent to those skilled in the art that different conventions can be adopted for moving the cursor further by multiple positions: instead of releasing and triggering again a sensor, holding the sensor in an active state will cause the repeat action. For example, the sequence FIG. 13 A, B, C, D, E, G, H, which omits FIG. 13 F, shows a repeat action of moving the cursor up caused by holding the top sensor in an active state in FIGS. 13 E and G.

Moving the shuttle in FIG. 7, 8, 9, 10, 11, 12, 13, 14, 15 may comprise the optional detent effects of snapping to fixed positions in a grid and of providing kinesthetic feedback to the user when the shuttle moves by an increment to the next fixed position.

FIG. 13A-H show that the cursor can be moved beyond the range of the shuttle by depressing the extension sensor—FIG. 13C and FIG. 13E). Further, the release action of FIG. 13D may be omitted with the effect of repeatedly moving the cursor if the extension sensor is being held in a depressed state for an extended period of time.

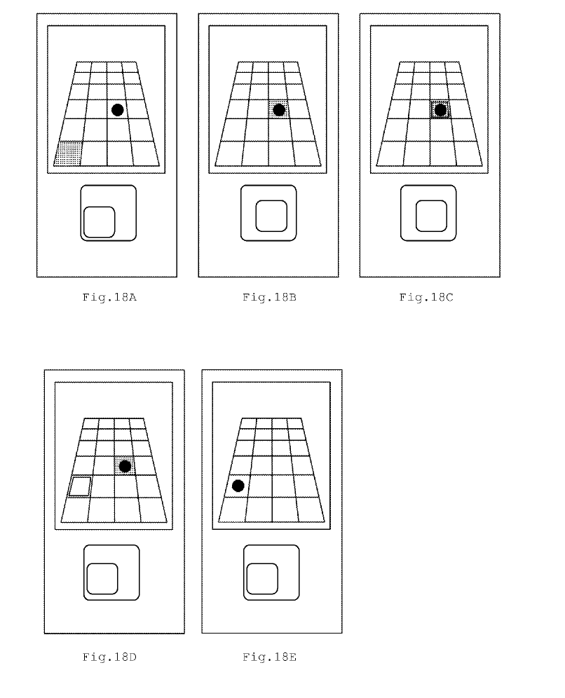

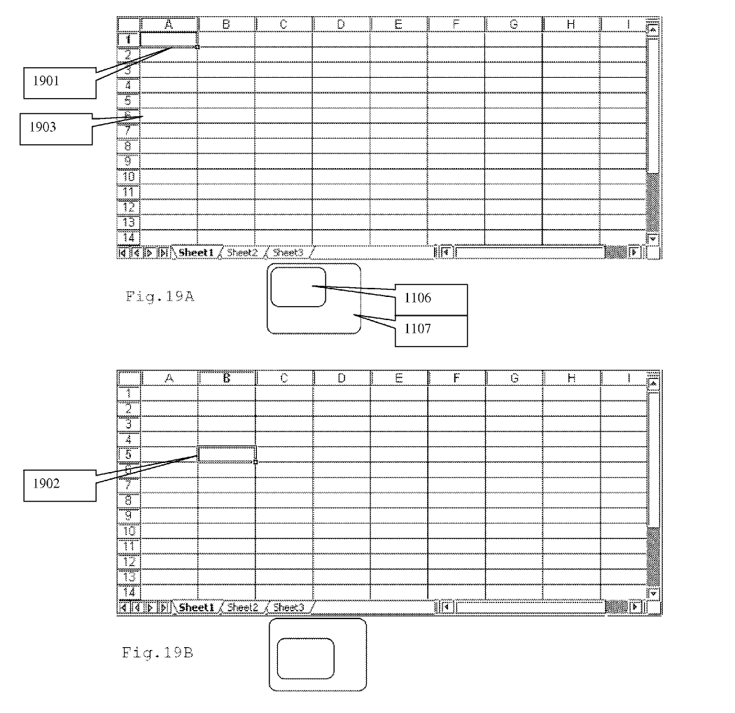

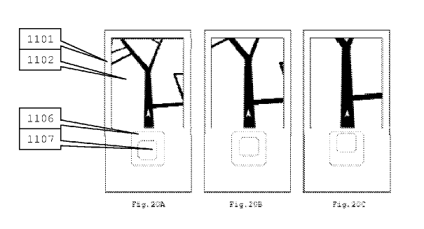

FIG. 14A,B,C,D,E,F,G,H,I,J,K,L show steps of another embodiment of said method for providing input information into a host system wherein said information consists of selections of menu items. A standalone sensor 1401 is being used for engaging and disengaging the cursor in situations where the cursor needs to be moved beyond the limit of the range of the shuttle.

In FIG. 14A, host 1101 comprises a display 1102 wherein said display is showing a menu 1201 comprising ITEM 1 through ITEM 7 and a cursor 1211 located over ITEM 3. The host 1101 further comprises an input device 1106 further comprising a shuttle 1107 capable of transversal and longitudinal movements. The host 1101 further comprises a standalone sensor 1401. As the shuttle moves up by one snap increment in FIG. 14B, the cursor moves up one item compared to FIG. 14A. As the shuttle moves up again in FIG. 14C, the cursor moves up further one item. As the shuttle moves up again in FIG. 14D, the cursor moves up further one item. Triggering the standalone sensor (for example, if the sensor is a button, the sensor can be triggered by depressing the button) as in FIG. 14E causes the cursor to disengage. The shuttle moves down in FIG. 14F,G,H but the cursor remains at the same location as in FIG. 14E because the sensor is still being triggered. In FIG. 14I,J,K,L, the sensor is released (not triggered) and the cursor is engaged again: while the shuttle moves up, the cursor moves up further.

It will be apparent to those skilled in the art that different conventions can be adopted for engaging and disengaging the cursor: touching a touch sensor, sliding a button, manipulating a lever, and so forth can cause the same effect as triggering the standalone sensor 1401. Moving the shuttle in FIG. 14 comprises the optional detent effects of snapping to fixed positions in a grid and of providing kinesthetic feedback to the user when the shuttle moves by an increment to the next fixed position.

FIG. 14A-L show that the cursor can be moved beyond the range of the shuttle by a rewind action which consists of moving the shuttle without moving the cursor while a click sensor 1401 is being held in a depressed state.

A further example of the present application is a method for navigation of graphic pictures, icons, windows in a graphical operating system—such as the Windows XP operating system—hyperlinks, or text fragments—hereinafter graphs—displayed on the display wherein the method comprises the said input device, at least one graph, and a cursor located over one of the graphs wherein the cursor is capable of traveling from one graph to another. The graphs are ordered in a first sequence (FIG. 15A) by an ordering method such as the coordinates of some of their features such as the top left corner coordinates, by the level of depth in the case of overlapping graphs—such as windows—, by a unique identifier number assigned at the time of creation of the graph, by the time of opening the graph, or by any other method capable of defining a unique next graph for each graph in the sequence. The next graph of the last graph in one of the sequences is by convention the first graph in the respective sequence. The graphs are also ordered in a second sequence (FIG. 15B) by another ordering method. Moving the shuttle in the transversal direction causes the cursor to travel to the next graph in the first sequence; moving the shuttle in the transversal direction causes the cursor to travel to the next graph in the second sequence. Preferably, the direction of movement of the cursor is substantially the same as the direction of movement of the shuttle. Optionally, at least a third sequence (FIG. 15C) can be formed by an ordering method different from the two said ordering methods, with a next graph convention similar to the next graph conventions described above. Clicking on the click sensor causes the cursor to travel to the next graph in the third sequence.

A further example of the present application is a method for graphical image manipulation, moving a cursor in a screen area, navigating menus, panning a viewport, navigating icons, navigating forms, and for providing input into a graphical user interface wherein said method comprises a said input device and steps of depressing or releasing the shuttle, the steps of moving the shuttle transversally or longitudinally while the shuttle is being depressed or released, the step of moving the cursor transversally in response to transversal movements of the shuttle while the shuttle is being depressed, the step of moving the cursor longitudinally in response to longitudinal movements of the shuttle while the shuttle is being depressed, and the steps of moving the shuttle transversally or longitudinally without moving the cursor while the shuttle is being released but engaged with a substantially transversal or longitudinal force that is strong enough to move the shuttle and a vertical force that is too small to depress the shuttle but strong enough to provide friction between shuttle and the engaging user member.

A further example of the present application is a method for graphic image manipulation wherein the method comprises more than one said cursor and more than one said shuttle, wherein each the shuttle causes one cursor to move in response to moving the respective shuttle as in FIG. 17. The shuttles may be located substantially on a front panel of the said input device, on the sides of the said input device, on the back of the said input device, or on several different surfaces of the said input device. In one embodiment, two shuttles 1701 and 1702 are mounted on the front panel of the said input device to facilitate manipulation by thumbs while simultaneously holding the device. In another embodiment, two shuttles are mounted on the front panel of the said input device and eight shuttles are mounted on the back panel of the said input device to facilitate simultaneous holding and manipulation of the device with multiple fingers. In another embodiment, the said method for graphical image manipulation may include two said input devices, wherein a first input device provides commands of panning a viewport—viewable part of a working image capable of being shown on a screen—by moving the shuttle of the first input device in two dimensions—up-down and left-right—and a second input device provides commands of moving a cursor on a screen by moving the shuttle of the second input device in two dimensions. Optionally, either one of the said first and second input devices may or may not comprise detent systems, or may comprise detent systems that can be disabled and enabled by the user. A further example of the present application is a method for providing player input to video games, computer games, and mobile phone games, preferably board games that involve a substantially rectangular grid of cells arrangement of movable tokens on a board as it showed in FIG. 18A. The method comprises at least one of said input device and preferably the steps of: moving the shuttle in preset increments of travel distance; moving a cursor on a board in response to moving the shuttle so that each increment of move of the shuttle causes the cursor to travel one cell substantially in the direction of the move of the shuttle as in FIG. 18B; selecting an token on the board by depressing the shuttle when the cursor is located on the cell containing the token FIG. 18C; selecting a target cell on the board by moving the shuttle, moving the cursor to desired cell in response to shuttle movements as described above, and depressing the shuttle FIG. 18D; moving the selected token to the target cell in response to depressing the shuttle as in FIG. 18E. Further, the user may depress a click sensor to achieve the functions described above for depressing the shuttle.

A further example of the present application is a method for using a business software application such as the Excel program sold by Microsoft Corp. of Redmond, Wash., USA or the Lotus Notes program sold by IBM Corp. of Armonk, N.Y., USA that comprise a user interface containing a sheet of cells as in FIG. 19A. The method comprises a cursor which is located on a cell in the sheet. Each move of the shuttle by a preset increment causes the cursor to travel preferably one cell in substantially the same direction as the shuttle move FIG. 19B. Selection of the contents of a cell for editing and move of the contents of a cell to another cell is preferably performed in a manner similar to the selection and move of tokens on a board game described above.

FIG. 19A,B show steps of another embodiment of said method for providing input information into a host system wherein said information consists of selections of cells in a spreadsheet program. In FIG. 19A, the spreadsheet comprises a cursor 1901 located over one of the cells wherein said cursor is capable of being moved transversally (left or right) and longitudinally (up or down) substantially in the same direction as the shuttle 1107 of an input device 1106. FIG. 19B shows the positions of said cursor and said shuttle wherein the shuttle moved down 4 increments and right one increment compared to the original positions in FIG. 19A, and correspondingly the cursor has relocated to position 1902 which is located 4 cells down and 1 cell right from position 1901.

A further example of present application is a method for providing commands for a map navigation program using the said input device. In one embodiment, the said method includes steps of map panning by moving the shuttle transversally or longitudinally, and steps of zooming in and out by depressing the click sensors. Further, the said method may comprise steps of map panning by depressing the extension sensors and steps of zooming in and zooming out by moving the shuttle up and down, wherein the said steps of zooming in are shown in FIG. 25 20A-20C. Further, the said method may comprise the said input device wherein the shuttle further comprises two sensors, the step of zooming in by depressing a first sensor located on said shuttle, the step of zooming out by depressing a second sensor located on said shuttle, and the steps of map panning by moving the shuttle transversally or longitudinally.

In FIG. 20A,B,C, moving the shuttle 1107 upwards causes the image 1102 to zoom in. Moving the shuttle down causes the said image to zoom out. The right movement of the shuttle causes said image to tilt so that more of the width of the image 1102 can be comprised within the width of the display 1101. In another embodiment, the transversal movement of the shuttle causes the image to pan or flip to the next page.

A further example of the present application is a method for providing input to a computer program for drawing, drafting, design, visual code generation, and the like, by controlling a cursor with the said input device. The cursor moves substantially in the same direction and by a distance proportional to the travel of the shuttle. The selection of an already drawn graphic feature—such as a shape, a line, the endpoint of a line, a point in a shape—and the move of a graphic feature from one location to another a target location are done preferably as described above for selecting and moving a token on a board game: locate the feature by moving the cursor in response to moves of the shuttle, select the feature by depressing the click sensor when the cursor is located on the feature, and locate and select a second location for moving the feature to the second location by moving the cursor in response to moves of the shuttle and by depressing the click sensor when the cursor is located at the target location.

A further example of the present application is a method to control at least two numeric parameters of a dynamic system wherein the method comprises at least one of the said input device and the system comprises at least a first numeric parameters and a second numeric parameter and the method comprises the following steps: the step of moving the shuttle in the longitudinal direction and the first parameter changing in response to moving the shuttle; and the step of moving the shuttle in the transversal direction changing the second parameter in response to moving the shuttle. In one embodiment, the dynamic system is a flying object, the first parameter is the intended pitch of the flight, and the second parameter is the horizontal angle between the intended and the current directions of flight.

A further example of the present application is the said input methods wherein repeated depressing of the sensors of an arrow key pad, dragging the finger on a touchpad, or tilting a joystick are used to control the movements of a cursor, viewport, or focus on a computer screen instead of the said input device. The actions of depressing an arrow sensor, dragging a finger on a touchpad by a certain increment, dragging a mouse by a certain increment, or tilting the joystick produce the effects described above for moving the shuttle in said input device. The said actions are semantically equivalent to the actions of moving the shuttle of said input device by a certain increment between two stable detent positions. The actions of depressing a selection sensor, briefly touching or double-touching the touchpad, or depressing a joystick sensor produce the effects described above for clicking the shuttle in said input device. A further example of the present application is a method for emulating a said input device by providing non-visual feedback such as tactile, haptic, kinesthetic, acoustic, or vibration feedback akin to a detent system when the user performs the actions of depressing an arrow sensor, dragging a finger on a touchpad, dragging a mouse, or tilting a joystick. It will be apparent to those skilled in the art that other devices may be used to achieve the effects of moving the cursor, viewport, and focus as described above when performing actions semantically equivalent to those of moving the shuttle of said input device by a certain increment—between two stable detent positions—, and optionally generating the said non-visual feedback.

The user may further have the option to configure the said input device so that all moves of the shuttle occur in preset increments and the user further has the option to set the size of said increments in the longitudinal and transversal directions of movement of the cursor, and the user further has the option to switch between a mode of movement where the shuttle and the cursor move in preset increments and a second mode of movement where the shuttle and cursor move substantially in a flowing unbroken movement in response to a force applied by the user on the shuttle in the longitudinal or transversal directions—the shuttle moves substantially continuously in response to the force and the cursor moves in increments of one pixel of the display.

Further, the shuttle is capable of being depressed to one of several vertical positions by using increasing vertical force. In one embodiment, this capability is ensured by a detent system for the shuttle positioned in a vertical layout together with a vertical compression spring. This permits to assign different semantics to gliding movements of the shuttle. For example, in one embodiment, shuttle gliding movements while the shuttle is in the most depressed position cause fast movements of the cursor stopping only at icons on the screen; shuttle gliding movements while the shuttle is in an intermediate depressed position cause the cursor to move in smaller increments, pixel by pixel, akin to a mouse; and gliding movements while the shuttle is not depressed but engaged with substantially horizontal forces cause the cursor to execute no movements to permit a rewind action for the position of the shuttle.

Further, parts of the shuttle are capable of being depressed independently in response to vertical force being applied in different areas of the shuttle by the user finger. In one embodiment, each of said parts of the shuttle comprises a depressible sensor.

Further, the shuttle is further capable of being engaged in a rotational movement around a vertical axis by at least one user finger or thumb, providing further selection information to a host system according to the rotational angle of the shuttle. The shuttle is further capable of being drawn to preset rotational angles by a detent system with preset positions such as the aforementioned wheel encoders.

In one embodiment, the current application uses components found in a computer mouse. Referring to FIG. 28, a user hand holds chassis 2816 and the thumb of said hand engages padshaped shuttle 2817 in a two-dimensional gliding movement. Said shuttle engages rod 2818 in a substantially up-down movement with respect to the figure which engages gear wheels 2804 and 2805 in simultaneous rotation movements wherein said wheels gear with linear gears that are affixed to said chassis. Said shuttle also engages rod 2819 in a substantially left-right movement with respect to the figure which engages gear wheels 2807 and 2803 in simultaneous rotation movements wherein said wheels gear with linear gears that are affixed to said chassis.

Gear wheel 2805 engages the shaft of wheel encoder 2801 in a rotational movement by means of rod 2802, joint 2814, and rod 2820. The detent mechanism comprised within wheel encoder 2801 causes the shaft of said encoder to rotate to the closest of a set of fixed angular orientations and said shaft causes rod 2818, in turn, to travel to the closest of a set of fixed locations. Wheel encoder 2801 further generates electrical signals carrying information regarding the rotation of said shaft, wherein said signals are transmitted to a computer mouse circuit 2822 wherein said circuit further converts the said information into the USB protocol and transmits the said information via USB cable 2810 to USB hub 2812.

Sensor 2806 is affixed to shuttle 2817 and said sensor is capable of being depressed by said thumb. Said sensor is connected to circuit 2823 by cable 2824.

Gear wheel 2803 engages the shaft of wheel encoder 2825 in a rotational movement by means of rod 2809, joint 2815, and rod 2821. The detent mechanism comprised within wheel encoder 2825 causes the shaft of said encoder to rotate to the closest of a set of fixed angular orientations and said shaft causes rod 2819, in turn, to travel to the closest of a set of fixed locations. Wheel encoder 2825 further generates electrical signals carrying information regarding the rotation of said shaft, wherein said signals are transmitted to computer mouse circuit 2823 wherein said circuit further converts the said information into the USB protocol and transmits the said information regarding shaft rotation of wheel encoder 2825 and information regarding the depressed state of sensor 2806 via USB cable 2811 to USB hub 2812. USB hub 2812 further sends the information it receives from said wheel encoders 2825 and 2801 and said sensor 2806 to a computer via USB cable 2813.

It will be apparent to those skilled in the art that the click sensors, extension sensors, and the clickable part of the shuttle surface can be implemented Further by pressure sensors, capacitance sensors, touch sensors, or other sensor solutions. Further, the said sensors and clickable shuttle are optionally capable of providing audio, acoustic, tactile, kinesthetic, vibration, or visual feedback to the user.

It will be apparent to those skilled in the art that the said feedback in embodiments described in this application may be Further implemented by visual feedback in the form of visual widgets, shapes, or symbols drawn on a computer screen or an electronic display or by causing lighting elements to shine. Said lighting elements may comprise for example LEDs embedded into a front panel or into the sensors or into the shuttle.

The present application further comprises a method of inputting strokes for Chinese characters by dragging said shuttle to a middle or end position of a stroke, then rotating said shuttle to the angle of the stroke, then depressing the shuttle to enter the stroke. Various stroke parameters such as length can be further determined by depressing click sensors located on the shuttle or the housing, by the vertical force applied to depress the shuttle, or by the number of clicks on the shuttle or other click sensors—singleclick or double—click.

The present application further comprises a method of providing haptic feedback to the user finger by elevating one or more parts of the shuttle surface that comes in contact with the user finger wherein the elevation depends on the current position of the shuttle. This elevation effect can be obtained for instance by electrical actuators located on the shuttle. Further, the said shuttle is capable of providing further tactile feedback to the user finger by generating a vibration that depends on the position of the shuttle. This vibration can be generated by an electrical motor, a miniature speaker, or another vibrating device affixed to the shuttle or the housing. In one embodiment, this elevation or vibration tactile feedback can be used to provide the sensation of a home row for typing by enabling the feedback when the shuttle hovers over letters F or J in a QWERTY keyboard layout. In another embodiment, the elevation or vibration varies by the distance from the edge of the shuttle span area. Further, the said elevation or vibration may depend on the speed and direction of movement of the shuttle.

A further example of the present application has an accessory system comprising at least one said input device and at least one audio output port—such as a connector for an audio speaker—and a host wherein said host can be a microprocessor based system such as a personal computer, a handset computer, a mobile phone, a personal digital assistant, or the like. Said input device or devices are communicatively connected to said host which is further capable of generating electrical signals on said audio output port as an audio feedback to the user. Further, said audio feedback may comprise clicking sounds akin to the sound of depressing a computer mouse sensor, tones akin to the sounds of a touch tone telephone, an artificial voice feedback reading text from a user interface, or the like. The said text from a user interface may include labels of icons and menu items on a screen, names from a contact list, phone numbers, or the like. The said artificial voice feedback may include software components akin to the artificial voice components found in accessibility features of computer operating systems such as Mac OS X produced by Apple Inc. of Cupertino, Calif., USA and Windows Vista produced by Microsoft Corp. of Redmond, Wash., USA. Said host is capable of communicating with said input devices and said audio output port by remote communication devices such as Bluetooth, infrared, USB, or the like. Said accessory system may be used as an add-on to mobile phones, wherein said artificial voice may be cast by a speaker on the phone or by a headphone in a hands-free set communicatively connected to the phone. Further, said accessory may be used as a computer peripheral, remote control for a TV set, and the like.

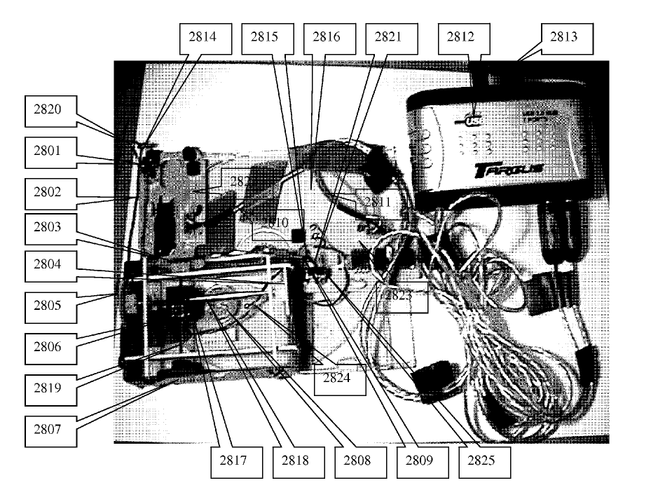

A further example of the present application is a said input device further comprising a converter circuit capable of generating electrical signals that simulate depressing arrow key sensors. FIG. 22A represents an arrow key sensor pad as used in most mobile telephones, computer keyboards, remote controls, and the like. Each sensor acts as an on-off switch that realizes an electrical connection while the sensor is being depressed; the left arrow sensor connects signals L1 and L2, the right arrow sensor connects signals R1 and R2, and so on. FIG. 22B represents a circuit that converts signals A and B of a wheel encoder into connections L1-L2 and R1-R2 which substitute the connections made by the left and right arrow sensors of an arrow key pad, respectively. In a further embodiment, said signals A and B assume the values shown in the waveform in FIG. 22C, as the hollow shaft of the wheel encoder turns right. When the hollow shaft of the wheel encoder turns left, said waveform is traversed in opposite direction, that is, the signals assume the values shown in the waveform as read from right to left.

During a right turn of the wheel encoder shaft, the pair of signals A and B goes through the sequence of values 00, 01, 11, 10, and then the sequence repeats. The flip-flop 2205 in FIG. 22B samples the value of A on the rising edge of B and stores the sampled value internally. Signal Q assumes the stored value and signal Q− assumes the inverted stored value on the falling edge of B. Therefore, when both A and B become low, the signals Q and Q−will be 10, enabling the connection between L1 and L2 via NMOS transistors 2201 and 2202 but disabling the connection between R1 and R2 via NMOS transistors 2203 and 2204. These connections achieve the same effect as if the left arrow sensor were depressed but the right arrow sensor were not depressed in an arrow key pad.

Similarly, a left turn of the wheel encoder shaft enables the connection between R1 and R2 but disables the connection between L1 and L2, as if a right arrow sensor were depressed but a left arrow sensor were not depressed in an arrow key pad.

The rising edge detector 2206 ensures that the said enabled connections are limited in duration so that they will not trigger undue repeat actions in the host system. Each turn of the wheel encoder shaft that goes through one complete iteration of the said sequence of A and B signal values represents one click of the right arrow sensor; if the said sequence is traversed from right to left, the iteration represents one click of the left arrow sensor.

A further example of the present application is an arrow key pad emulator device comprising the said input device and two said converters wherein a first converter converts signals of a first wheel encoder of said input device into signals that emulate depressing left or right arrow sensors and a second converter converts signals of a second wheel encoder into signals that emulate depressing up or down arrow sensors. A further example of the present application is a remote control, handset, computer keyboard, musical keyboard, TV set, DVD player, or other electronic equipment comprising at least one said arrow key pad emulator device. A further example of the present application is the method of designing a control panel such as a remote control for a computer, a remote control for electronic equipment, a keyboard, a panel for an electronic equipment, a PDA, and the like by replacing an arrow key pad by a said arrow key pad emulator.

It will be apparent to those skilled in the art that the said converter can be realized with other possible conventions for the signals of a wheel encoder, such as a waveform where the falling edges of A and B in FIG. 22C are nearly simultaneous. It will be apparent to those skilled in the art that the said converter can be realized with other circuits or circuit components, such as a microcontroller.

A further example of the present application is a method and apparatus for converting the signals of at least two wheel encoders of at least one said input device into signals that emulate the signals produced by a touch screen or touchpad device.

A further example of the present application is an accessory for mobile phones comprising a said input device and a ring on which the said input device is affixed so that the shuttle can be engaged by the user thumb while the ring is placed and held on the user finger as illustrated in FIG. 23. Optionally, the said accessory may comprise a wireless or wired communication means for communicating the signals from the movement sensing systems of the said input device to a mobile phone or to a personal computer that are capable of communication via said communication means. For example, said communication means comprise apparatus for communicating via the Bluetooth protocol. The said communication means may be located on the said ring, on a separate ring, on a wrist band, or on other locations affixed to a user member or the user body. A battery or another source of electrical power may be located on the said communication means or on the ring comprising the said input device. The said communication means further comprise electrical conductors for transmitting signals and electrical power between the ring comprising the said input device and the said communication means.

A further example of the present application is a universal remote control comprising the said input device, a display, at least one microprocessor and a graphical user interface wherein the graphical user interface further comprises a cursor capable of moving longitudinally and transversally in response to moving the shuttle of the said input device.

The components of one or more of the examples of the present application that are in contact with a user member, such as a finger or a thumb, may execute a gliding movement wherein said components span a substantially flat volume, which permits the entire mechanism of the present application to be contained within a small overall volume. Furthermore, the present application has bounds in both directions of movement of the user-engaged component, which permits an absolute frame of reference for movements of components that are being engaged by the user.

The examples of the present application have improved usability because a single move of the user member can engage a component of the present application in a complex movement in a range of directions, and in the present application it is not necessary to disengage the user member in order to change the direction of movement by substantially a right angle.

The examples of the present application permit faster typing by executing several cursor moves with a single move of the user member that engages a component of the present application.

The examples of the invention allow a user to use a joystick to input Chinese characters to a data processing device by entering only the first few strokes required to write each character.

Generally, there are several Chinese input systems classified into two categories: keyboard-coding and handwritten stroke recognition.

A) In a keyboard-coding approach, the user enters the strokes of a character by pressing on the corresponding key or keys and chooses a desired character from a set of candidate characters are generated and presented on a display as matching alternatives. This approach can also be used found in a cellular telephone.

B) In a handwritten stroke recognition approach, the user writes a stroke using a special device such as electronic pen or a stylus and the computer compares the user's stroke with a large number of collections in the database to recognize it.

Both approaches are possible with the examples of the application. The examples of the present application may avoid overstretching of user fingers compared to the keyboard-coding approach because the present application does not necessarily require different user fingers or thumbs to travel at large distances from one another. Further, the examples of the present application may provide sufficient tactile and kinesthetic feedback for blind typing, unlike some other handwritten stroke recognition approaches. Further, the examples of the present application may provide means for navigation of graphical user interfaces, not just typing or character entry.

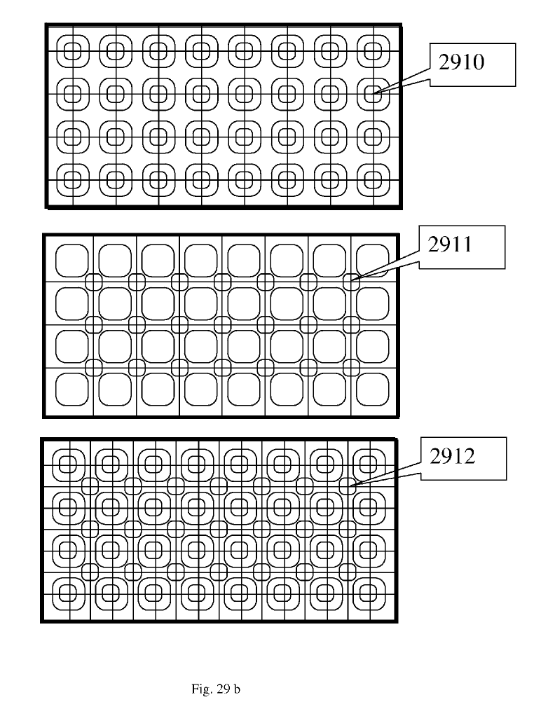

FIG. 29 shows an alternate implementation of the detent and encoder mechanisms, wherein said detent and encoder comprise a two-dimensional (2D) array layout. A substantially lens shaped pad 2901 is capable of being engaged by user thumb or finger in a gliding movement over a multi-layered surface—for example, by means of a mechanism such as those in FIG. 3A through FIG. 3E. Said multi-layered surface further comprises, from top to bottom, four layers 2902, 2904, 2906, 2908. The first layer 2902 further comprises holes 2903 arranged in an array layout. The second layer 2904 further comprises wires 2905 on the lower surface of said layer, wherein said wires are capable of conducting electrical signals. The third layer 2906 is made of an isolating material with holes 2907 arranged in a rectangular array. The fourth layer 2908 further comprises wires 2909 on the upper side of said layer wherein said wires are capable of conducting electrical signals.

In one embodiment (2910), holes 2902 and 2906 are centered above crossings of wires 2901 and 2905. When pad 2901 presses against a hole 2902, a contact is formed between the two wires located immediately below said hole. A controller device communicatively connected to said wires detects the low resistance between said wires and calculates the location of the pad from the known location of wires that have low resistance.

In another embodiment (2911), holes 2902 and 2906 are centered in the squares formed by wires 2901 and 2903. When pad 2901 presses against a hole 2902, up to four contacts are made by the neighboring wire crossings.

It will be apparent to those skilled in the art that the present application can be practised with varying implementations. Other embodiments may comprise a 2D encoder with two one-dimensional detent systems (wherein the moving parts are capable of linear or circular movement) or two one-dimensional encoders with a 2D detent system, a ball or rectangular shaped pad, or the surface 2902 may comprise elevated portions. The number of layers in the multi-layered surface may vary. The layouts of embodiments 2910 and 2911 may be combined as shown in 2912 by having wire crossings both under and in between holes 2902.

The examples of the present application also present a system and method for automatically switching between writing and text input modes, informing the system of the user's intentions so as to handle pen events in the manner desired by the user. The present application can alleviate hand jitter by avoiding the use of a pen or stylus with a free hand.

Inputting text is a problem for many handset devices such as cell phones. The examples of the invention can reduce the number of keystrokes using word- or block-based predictive text input. The examples can also support typing of a word based on pressing keys wherein each key can be interpreted as several distinct alternative characters. The examples of the application do not necessarily require the use of a vocabulary of words stored in the input system and thereby supports a reduced overall cost of said system by avoiding the use of memory elements to store the said vocabulary. The method of the application permits easy typing of addresses, names, and foreign words that are unlikely to be contained in a stored vocabulary. ‘Triple-tap’ or ‘multi-tap’ methods allow the user to select one of several letters displayed on a key by repeatedly depressing a key, thereby also selecting one of two letters displayed on a key by depressing said key once or twice. The examples of the present application provides high speed of typing by selecting a key with a single stroke, and the present application has Internet browsing capability as well.

The examples of the application also can support control of a digital watch by displaying a menu of choices and a selector sensor used to designate and select the desired choice. The examples of the application also are capable of traversing a set of options arranged in an array by moving on a short path rather than traversing the said options linearly.

The examples of the application can be used to pan a viewport relative to a block of stored information only part of which is selectable to be viewed through the viewport. When the cursor is moved outside the viewport of the display, the viewport is panned to include the cursor. The proposed application, however, provides tactile and kinesthetic feedback on moving the cursor.

The examples of the application also support methods to select characters with a slider. Characters are displayed along the length of a scroll bar and a slider is provided which may be selectively positioned over a character displayed on the scroll bar, resulting in the CPU displaying help data entries corresponding to the selected character. The proposed application, is capable of providing tactile and kinesthetic feedback when moving the slider.

The examples of the application also permit multi-dimensional scrolling of overlapping data collections which are displayed in multiple layers or in a simulated three-dimensional manner within a data processing system. The present application also provides kinesthetic feedback to the user when the scrolling steps are executed.

The examples of the application also may support a scrolling method which determines whether the user is holding down a command sensor while the mouse pointer is either placed over the slider on a scroll bar or over one of the directional sensors. The present application also provides kinesthetic feedback to the user and the accuracy of the selection is improved by snapping to predetermined positions.

The examples of the application also may applied to a trackball cursor control apparatus which provides the user with tactile feedback corresponding to uniform incremental movements of the cursor about both axes of movement. However, due to gliding movements the present application is capable of being implemented in a substantially flat shape that can be easily embedded into a front panel.

The examples of the application also can support solutions for menu navigation by controlling knob devices including improved force feedback. Gliding movements of the examples of the present application can be implemented in a substantially flat shape that can be easily embedded into a front panel.

The examples of the application also can support the use of a touch sensitive switch and several keys to allow a user to interface with the Internet. The present application offers ways of entering data such as text and numbers and it supports single-hand operation.

The examples of the application also can be applied to an active keyboard system for inputting data and commands. The input means then may include at least one selector—that can be a wheel, a track ball, a joystick, a rocker pad, a touch pad, a selector switch, a toggle switch, a key sensor, an N-state sensor, or an N-state selector configured to be operated by a thumb or other finger, and a plurality of keys. This system permits rapid selection of an item in a two dimensional array. However, the present application is capable of being operated by a single user member—such as a single finger, thumb, tongue, etc.

The examples of the application also can support a touch sensor array built in a similar manner as a TFT active matrix liquid crystal display which offers comparable resolution as the liquid crystal display. The method of the examples can also be applied to a keyboard that uses chord keying. Mention is made of the possibility of realizing the keyboard using touch keys rather than mechanical keys. The present application provides kinesthetic feedback to the user finger.

The examples of the application also may provide for a computer input device in which the functions of both a keyboard and a mouse are realized compactly using a touch-sensitive pad. The present application does not necessarily require the use of a touch sensitive pad and therefore the accuracy of the input is not dependent on large variations of shape of the touch print of the user members.

The examples of the application also may provide a solution which allows a user to scroll both focusable and non-focusable areas in an efficient manner. The semantics of scrolling depends on the type of item on which the cursor is positioned. The present application is capable of scrolling in two substantially orthogonal directions within a viewable area.

The examples of the application also be applied in order to provide an integrated solution using one set of keys or tools for all 3 major operational functions of a handheld device: navigation and control, text input and phone dialing. The present application also provides kinesthetic feedback when moving a cursor.

The examples of the application provide a haptic feedback device with low manufacturing cost which offers the user compelling haptic feedback to enhance the interaction with computer applications. Manufacturing costs are reduced by the present application by using scroll wheel encoder components that provide kinesthetic feedback by storing energy from movement of the user's fingers rather than providing haptic feedback to shuttle movements by active elements.

The examples of the application provide—among others—a slidable element mounted on an electronic device that is operable to change the display configuration and divide the display screen into different functions. However, the present application is capable of moving a slidable element in two substantially orthogonal directions within a viewable area.

The examples of the application can also be applied as an ergonomic hand controller pointing device based on fingeractuated touch switches in order to minimize hand muscle fatigue. A possible example provides an ergonomic combination of mouse and track ball unit. An ergonomic pointing device asserts that by enlarging and modifying the shape of a mouse the user's fatigue will be decreased. It minimizes fatigue, discomfort and pain from sessions of extended mouse use by changing the orientation of the user's hand from generally parallel to the desk or work surface to a generally upright hand with the four fingers of the user's hand in extended but slightly bent positions in a generally upright stack with the thumb supported on the opposite side of the mouse. The present application also provides kinesthetic feedback when moving a cursor.

The examples of the application provide an ergonomic pointing device that positions the user's hand in a more ergonomically desirable position, the length of the input device is adjusted for the size of the user's hand. The present application provides a pointing devices and, simultaneously, a data input device.

The examples of the application can provide a micro keyboard for mobile phones, imitating computer keyboard placement with rotatable sensors, there is a controllable interlockmechanical means by the principle of displacement and rotation technique fixed inside keyboard. The method of inputting text in a mobile phone provided by the present application is also suitable for those users who want to input text while they are walking.

The examples of the application can provide means for controlling mobile phones, pocket computers control elements—sensors, joysticks, etc.—arranged on a body in such a way that a user can keep it in hand or carry in pocket. The present application permits significant user control with only one shuttle that performs the functions of multiple controls while requiring less user attention.

The examples of the application may also provide an input device for mobile devices that integrates in its functionality the right and left operation sensors such that the integrated operation sensor can be tilted right and left in a seesaw state. The present application is capable of being implemented in a substantially flat form factor.

For improving the control of a cell phone, the examples of the application provides a support board of the input assisting device that is equipped with a base part which has a terminal mount an a second part in its center, a control part third which has a control sensor, and an operation part fourth which has operation sensors. The present application is capable of being embedded into a cell phone and may be held and operated by a single user hand.

In the examples of the application, the keyboard may be replaced by a virtual keyboard pattern on the computer screen, selection of keystrokes is made by a mouse, or the like, positioning a cursor at a desired key for keyswitch selection. The resulting equipment therefore eliminates the conventional keyboard but not its operational advantages thereby permitting full computer operation with a mouse or equivalent. The present application makes it easy to entry text by a small number of movements needed for each keystroke and assistance via the kinesthetic feedback in obtaining focus on a key by biasing the said shuttle towards a preset point within the area of said key.

The examples of the application also can support a graphical text entry system which comprises a graphical text entry wheel containing a plurality of character and a pointing device for rotating the graphical text entry wheel and selecting a particular character. They can present a character input apparatus used for inputting any of 26 alphabetical characters ‘A, B, C, . . . , X, Y, and Z’. A character is selected by successively rotating an operation body and using the inclination direction of the operation body. They can relate to a portable information displaying apparatus for displaying information input with the same hand holding portable information apparatuses. The apparatus may have two lateral rollers. The present application is capable of moving a cursor in two substantially orthogonal directions.

According to the examples of the application, a method of controlling the user interface of a portable communication apparatus, so that graphical data, requiring a presentation area which is larger than the available limited presentation area of the display, may be navigated and presented flexibly and accurately with few steps of manual intervention. The present application can leverage kinesthetic feedback and snapping to a grid of positions.

The examples of the application relate to computer control devices, and particularly, to data entry devices which can be used for one or more functions such as two dimensional control of a cursor or marker on a computer display, and selection of program control signals like macros, textual display selection, etc. The present application can leverage kinesthetic feedback and snapping to a grid of positions.

The examples of the application also relate to computer input devices, and more particularly to a keyboard mounted cursor controller for use in moving a cursor on a video display screen. The present application can leverage kinesthetic feedback and snapping to a grid of positions.

The examples of the application further may relate to a device for controlling a cursor to rotate rightwards and leftwards and the method thereof, especially to a cursor controlling device for rotating a X axis movable optic grid and a Y axis movable optic grid to a proper angle, further, said cursor may be moved as intended. The present application can leverage kinesthetic feedback and snapping to a grid of positions.

Further applications of the examples of the application can relate to an x-y direction input device for moving a cursor on a screen in any direction. The present application leverages kinesthetic feedback and snapping to a grid of positions.

The examples of the application can relate to a cursor control device for a computer and, more particularly, to such a cursor control device which employs a zero-point resetting feature. The present application leverages kinesthetic feedback and snapping to a grid of positions.

The examples of the application can be applied to present improved digitizers for use in computer graphics. The digitizer has active elements: x and y drive motors and associated mechanisms are conventional elements of typical curve plotting devices. The drive motors in typical conventional curve plotter are conventional position servo motors. Curve plotters with stepper motors may be used. With stepper motor type curve plotters, the digital to analog converters are replaced with conventional digital stepper motor drive circuits. The examples of the application capable are of being carried in hand.

The examples of the application can relate to an operating device and, more particularly, to an operating device for menu-controlled functions of a vehicle which can be displayed symbolically on a screen and selected by an actuator which provides haptic feedback. The present application provides feedback by passive elements that have zero power consumption and a low manufacturing cost.

The examples of the application also relate to desk top computer control devices such as desk top operated mice, of the type having a rotatable ball for pointing control, and which further include depressible sensors which can be depressed inward to a main housing by the user's finger for scrolling applications in Windows or the like. The examples of the application also relate to a computer software used with this mouse for Internet navigation. The present application is capable of moving a cursor without comprising a mouse.

The examples of the application can relate to pointing devices and, more particularly, to a pointing device such as a joystick including a roller. The roller can be used for selecting an item from a menu. The present application is capable of moving a cursor in two substantially orthogonal directions and provides kinesthetic feedback.

The examples of the application can relate to an appliance whose program code stored in internal memory includes a menu/image navigation application program which allows the user to use navigation sensors to view multiple images as well as navigate menus. The present application does not normally require multiple strokes to reach an intended item or area.

The examples of the application also relate to a radiophone provided with an operation key which is an up/down key with multiple functionality for handling access to a menu structure. The present application does normally not require multiple strokes to reach an intended item or area.

The examples of the application also can be applied to a user interface of a mobile station that includes a display, a keyboard, and an operating knob for using menus. The rotatable operating knob can be moved between a first and a second position and, the rotating of which scrolls menus or changes the measure of the set value, and can be pushed to accept functions and pulled to undo functions. To implement this, the operating knob is arranged to be gripped with fingers. The present application is capable of reliable selection movements in two substantially orthogonal directions.

The examples of the application also can be applied to a terminal for wireless telecommunication and a method for displaying icons on a display of the terminal for wireless telecommunication that includes among other a scroll for example a jog dial, for scrolling through icons and highlighting a respective selected icon. At least some of all available icons of the menu are displayed on the display at the same time and the scroll can be actuated to scroll through the icons in at least two directions so that the respective selected icon is highlighted depending on the actuation of the scroll. The present application is capable of moving a cursor in two substantially orthogonal directions.

The examples of the application can also be applied to an image control system for controlling a menu on a display. The menu is arranged as a plurality of items in a loop. The selection is made with a software selector. The loop and the selector are moveable with respect to each other. The control device—that is a rotary dial positioned on the front face—has a loop configuration, with movement around the loop of the control device causing corresponding relative movement between the selector and the loop of the menu. The present application does not necessarily require a loop arrangement that takes a lot of area in the display and the present application also support other sequences of traversing the items on the display.

1-23. (canceled)

24. An input device for an electronic device comprising:
a still part for receiving a shuttle, the shuttle being moveable by a user with respect to the still part,
a movement sensing system for converting the position and/or the movements of the shuttle with respect to the still part into an electrical information, the movement sensing system being coupled to the shuttle,
an output for providing the electrical information to the electronic device,
a detent system for engaging the shuttle for providing feedback to the user when a moving part is displaced with respect to the still part, the detent system being coupled to the shuttle and/or to the movement sensing system, and
a sensor for a force substantially orthogonal on an area that comes in contact with the user.

25. Input device according to claim 24, wherein
the movement sensing system is coupled with the shuttle, such that a predetermined range of movement of the shuttle is transformed into a predetermined sensing range of the movement sensing system.

26. Input device according to claim 24, wherein
the movement sensing system comprises a gearing device such as a moveable lever assembly.

27. Input device according to claim 24, wherein
the still part comprises an essentially flat pad for guiding the shuttle.

28. Input device according to claim 24, wherein
the shuttle comprises a ball which is rotatably taken up by the still part.

29. Input device according to claim 24, wherein
the shuttle comprises a joystick.

30. Input device according to claim 24, wherein
the sensor is capable of being depressed.

31. Input device according to claim 24, wherein
the detent system provides a passive feedback, wherein
the position of the shuttle comprises stable equilibrium positions and unstable positions, whereby
the shuttle can move from an unstable position to a stable equilibrium positions without applying external force to the shuttle.

32. An input device comprising the following features:
a shuttle moveable by a user,
a movement sensing system coupled to the shuttle for converting positions and/or movements of the shuttle into an electrical information,
a sensor coupled to the movement system for a force applied by the user, and
a detent system coupled to the shuttle and/or to the movement sensing system for providing feedback to the user.

33. Electronic device such as a computer device, with an input device according to claim 32, wherein
the electrical information from the input device is provided for entering information into the electronic device.

34. Electronic device according to claim 33
providing the functions of a computer desktop, of a mobile phone, of a remote control, of a digital camera, of a computer mouse, of a computer keyboard, of a digital watch, or of a computer game console.

35. Computer program for controlling an electronic device according to claim 34, the electronic device further comprising
a display device with a movable cursor, wherein
the computer program links pre-determined positions of the shuttle with pre-determined positions of the cursor such that a movement of the shuttle to a pre-determined position provides a movement of the cursor to the pre-determined position on the display which is linked therewith.

36. Computer program according to claim 35, the electronic device further comprising
a display device, wherein
the computer program links pre-determined positions of the shuttle with predetermined images to be displayed on the display.

37. Computer program according to claim 36, wherein
the predetermined positions of the shuttle comprise positions where the detent system provides a feedback at a reduced level.

38. Computer program according to claim 36, wherein
the predetermined positions of the shuttle comprise positions where the detent system provides a feedback at an increased level.

39. Computer program according to claim 35, wherein
the input device comprises a sensor, wherein
a click can activate an object or an image at a predetermined position.

40. Method for moving a cursor or for changing the images on a display of an electronic device, the method comprising the following steps:
converting a position and/or movement of a finger of a user on the electronic device into an electrical information,
providing the electrical information into the electronic device, and
providing feedback to the finger of the user when the finger is displaced with respect to the electronic device.

41. Method according to claim 40 further comprising a step of moving a shuttle while sensing the feedback to the user depending on the position of the shuttle.

42. Method according to claim 40 further comprising a step of releasing the shuttle upon reaching a pre-determined position.

43. Method according to claim 40 further comprising a step of activating a sensor upon the shuttle reaching a predetermined position.
